(19) United States
(12) Patent Application Publication
(10) Pub. No.: US 2026/0064247 A1
(43) Pub. Date: Mar. 5, 2026

(54) AI-ASSISTED PROJECT CHANGE ORDER GENERATION

(71) Applicant: Oracle International Corporation, Redwood Shores, CA (US)

(72) Inventors: Roshan Manellore, Telangana (IN); Pyay Aung San, Redwood City, CA (US); Mannepalli Vineela, Telangana (IN); Chen Chen, Redwood Shores, CA (US); Mani Kumar Vran Kasibhatla, Telangana (IN); Deepak Gupta, Telangana (IN); Sreekar Gumireddy, Telangana (IN); Sravan Maringanti, Telangana (IN); Peter Weiss, Golden, CO (US)

(73) Assignee: Oracle International Corporation, Redwood Shores, CA (US)

(21) Appl. No.: 19/088,516

(22) Filed: Mar. 24, 2025

Related U.S. Application Data
(60) Provisional application No. 63/690,731, filed on Sep. 4, 2024.

(51) Int. Cl. G06F 3/0484; G06Q 10/10

(52) U.S. Cl. CPC G06F 3/0484; G06Q 10/103

(57) ABSTRACT

Systems, methods, and computer-readable media are provided for generating a prompt that specifies a plurality of fields and corresponding values of record(s). The prompt specifies a data structure to use for filling in components of a change order and includes a particular natural language description of a particular issue that caused the change order. A large language model is prompted with the prompt to generate a result based at least in part on the corresponding values of the record(s). The result from the large language model includes a particular data structure comprising particular values of a particular change order, which may then be displayed on a user interface along with an option to save the particular change order. Information from the record(s) and/or result(s) from the large language model may indicate whether or not manual labor, financial resources, and/or other resources are impacted by the change, and an impact may be stored in association with the change order reflecting a corresponding type of impact. The user interface may display another option to provide natural language input to modify the particular change order, causing the large language model to be re-prompted to generate another result to trigger change order creation.

### CROSS-REFERENCE TO RELATED APPLICATION(S)

This application claims the benefit of U.S. Provisional Patent Application No. 63/690,731, filed on Sep. 4, 2024. The entire disclosure of the aforementioned application is incorporated by reference herein in its entirety for all purposes.

### BACKGROUND

Organizations use software to keep track of projects, supplies, materials, resources, tasks, schedules, and any other digital representation of valuable information to the organization. Such digital representations of information may be stored in one or more underlying databases and made viewable, accessible, or modifiable via user interfaces provided by applications that embed information about items of the information from the database to portions of the user interface. Users may interact with the items to make changes and store the items back to the database as changed.

### BRIEF SUMMARY

In some embodiments, a computer-implemented method includes prompting and optionally re-prompting a large language model to generate a change order based on underlying fields and/or natural language input. The method includes generating a prompt that specifies a plurality of fields and corresponding values of one or more records. The corresponding values are filled into a prompt template having placeholders for the corresponding values. The prompt specifies a data structure to use for filling in components of a change order. The prompt further includes a particular natural language description of a particular issue that caused the change order. A large language model is prompted with the prompt to generate a result based at least in part on the corresponding values of the one or more records. Information from the one or more records and/or result(s) from the large language model may indicate whether or not manual labor, financial resources, and/or other resources are impacted by the change, and an impact may be stored in association with the change order reflecting a corresponding type of impact. The user interface may display another option to provide natural language input to modify the particular change order, causing the large language model to be re-prompted to generate another result to trigger change order creation. The other result from the large language model may be received, including another particular data structure comprising other particular values of another particular change order. The other particular change order may be displayed along with an option to save the other particular change order. For example, a regenerate option may be selected along with additional or revised text to cause updating the change order before it is saved as updated.

In a further embodiment, the computer-implemented method includes causing display of another option to provide natural language input to modify the particular change order. The computer-implemented method further includes receiving particular natural language input via a selection of the other option. The computer-implemented method further includes re-prompting the large language model to generate another result based at least in part on the particular change order and the particular natural language input. The computer-implemented method further includes receiving, from the large language model, another result, wherein the other result comprises another particular data structure comprising other particular values of another particular change order. The computer-implemented method further includes causing display of the other particular change order and an option to save the other particular change order.

In a further embodiment, the computer-implemented method includes classifying the particular change order based at least in part on the particular values of the particular change order and a list of candidate change reasons provided in the prompt, and storing a classification as part of the particular change order. In this embodiment, the classification is determined based at least in part on the large language model selecting a change reason from the list of candidate change reasons provided in the prompt.

In the same or a different further embodiment, the computer-implemented method includes determining one or more quantified impacts of the particular change order, and storing the one or more quantified impacts as part of the particular change order in a database.

In the same or a different further embodiment, the computer-implemented method includes classifying an impact of the particular change order based at least in part on the particular values of the particular change order, and storing a classification as part of the particular change order in a database. In this embodiment, the classification is based at least in part on whether the particular change order describes a change including manual labor.

In the same or a different further embodiment, the placeholders include a placeholder for a particular natural language description of a particular issue that caused the change order, and the prompt has the natural language description of the issue at a position that is based on the placeholder.

In the same or a different further embodiment, the placeholders include a placeholder for range-limiting criteria for a field. The prompt has the range-limiting criteria of the field at a position that is based on the placeholder. In this embodiment, the result comprises a value for the field that complies with the range-limiting criteria. In a further embodiment, the prompt further includes different input examples having different range-limiting criteria and different output examples corresponding to the different input examples.

In the same or a different further embodiment, the prompt includes a particular natural language description of a particular issue that caused the change order. The prompt further includes different input examples having different natural language descriptions of issues and different output examples corresponding to the different input examples. The different output examples have different numerical values for an output field. The different numerical values quantify different absolute impacts of changes based on the issues. In this embodiment, the particular values in the particular data structure include a particular numerical value for the output field that quantifies a particular absolute impact of the change order.

In the same or a different further embodiment, the prompt includes a particular natural language description of a particular issue that caused the change order. The prompt further includes different input examples having different natural language descriptions of issues and different output examples corresponding to the different input examples. The different output examples have different numerical values for an output field. The different numerical values quantify different relative impacts of changes based on the issues that are not further quantified into absolute impacts. In this embodiment, the particular values in the particular data structure comprise a particular numerical value for the output field that quantifies a particular relative impact of the change order. The particular data structure does not include an absolute amount from which to further quantify the particular relative impact. The computer-implemented method further includes retrieving, based at least in part on one or more values of the one or more records that were omitted from the prompt, a particular absolute amount. The computer-implemented method further includes transforming the particular relative impact into a particular absolute impact based at least in part on the particular relative impact and the particular absolute amount.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process that prompts and optionally re-prompts a large language model to generate a change order based on underlying fields and/or natural language input.

FIG. 2 illustrates a system diagram showing an example system that prompts and optionally re-prompts a large language model to generate a change order based on underlying fields and/or natural language input.

FIG. 3 illustrates an example user interface showing issues that may be used to create change orders.

FIG. 4 illustrates an example user interface showing a detailed view of an issue that may be used to create a change order.

FIG. 5 illustrates an example user interface showing an option to initiate a change order based on an issue and/or additional natural language text.

FIG. 6A illustrates an example user interface showing an initial change order generated based on the issue.

FIGS. 6B and 6C illustrate example user interfaces showing change orders generated based on the issue with additional natural language text typed into a user input region.

FIG. 6D illustrates an example user interface showing a regenerated change order generated based on the natural language text typed into the user input region from FIG. 6C.

FIGS. 7A and 7B illustrates example user interfaces showing example change orders created as a result of processes described herein.

FIG. 8 illustrates a flow chart showing an example process that prompts and optionally re-prompts a large language model to generate a change order based on underlying fields and/or natural language input.

FIG. 9 illustrates an example workflow of creating change orders to address issues.

FIG. 10 illustrates an example user interface showing a project with many separate phases that are progressing depending on any issues that may impact the progress.

FIG. 11 illustrates an example user interface showing an impact assessment for a change order.

FIG. 12 illustrates an example user interface showing a detailed editable view of the impact assessment for the change order.

FIG. 13 depicts a simplified diagram of a distributed system for implementing certain aspects.

FIG. 14 is a simplified block diagram of one or more components of a system environment by which services provided by one or more components of an embodiment system may be offered as cloud services, in accordance with certain aspects.

FIG. 15 illustrates an example computer system that may be used to implement certain aspects.

### DETAILED DESCRIPTION

A description of prompting and optionally re-prompting a large language model to generate a change order based on underlying fields and/or natural language input is provided in the following sections:
DISPLAYING INFORMATION RELATING TO POTENTIAL CHANGE(S)
GENERATING A CHANGE ORDER
PROMPTING A LARGE LANGUAGE MODEL TO GENERATE THE CHANGE ORDER
PROMPTING A LARGE LANGUAGE MODEL TO REVISE A CHANGE ORDER
AUTOMATED IMPACT ASSESSMENT
AUTOMATED PREDICTION OF WHETHER CHANGE REQUEST WILL BE APPROVED
AI-ASSISTED PROJECT CHANGE ORDER GENERATION EXAMPLES
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

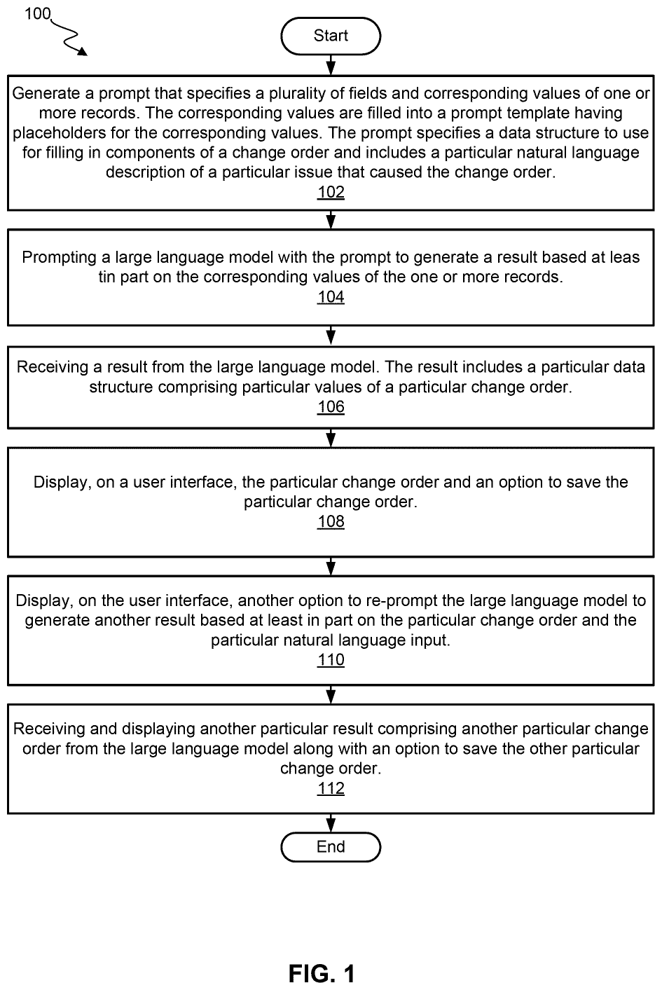

FIG. 1 illustrates a flow chart of an example process 100 that prompts and optionally re-prompts a large language model to generate a change order based on underlying fields and/or natural language input. In block 102, a data management system generates a prompt that specifies a plurality of fields and corresponding values of one or more records. The corresponding values are filled into a prompt template having placeholders for the corresponding values. The prompt specifies a data structure to use for filling in components of a change order and includes a particular natural language description of a particular issue that caused the change order. In block 104, a large language model is prompted with the prompt to generate a result based at least in part on the corresponding values of the one or more records. A result is received in block 106. The result from the large language model includes a particular data structure comprising particular values of a particular change order, which may then be displayed, in block 108, on a user interface along with an option to save the particular change order. In block 110, the user interface may display another option to provide natural language input to modify the particular change order. Particular natural language input may be received pursuant to the other option, and the large language model may be re-prompted to generate another result based at least in part on the particular change order and the particular natural language input. In block 112, another result from the large language model may be received, including another particular data structure comprising other particular values of another particular change order. The other particular change order may be displayed along with an option to save the other particular change order.

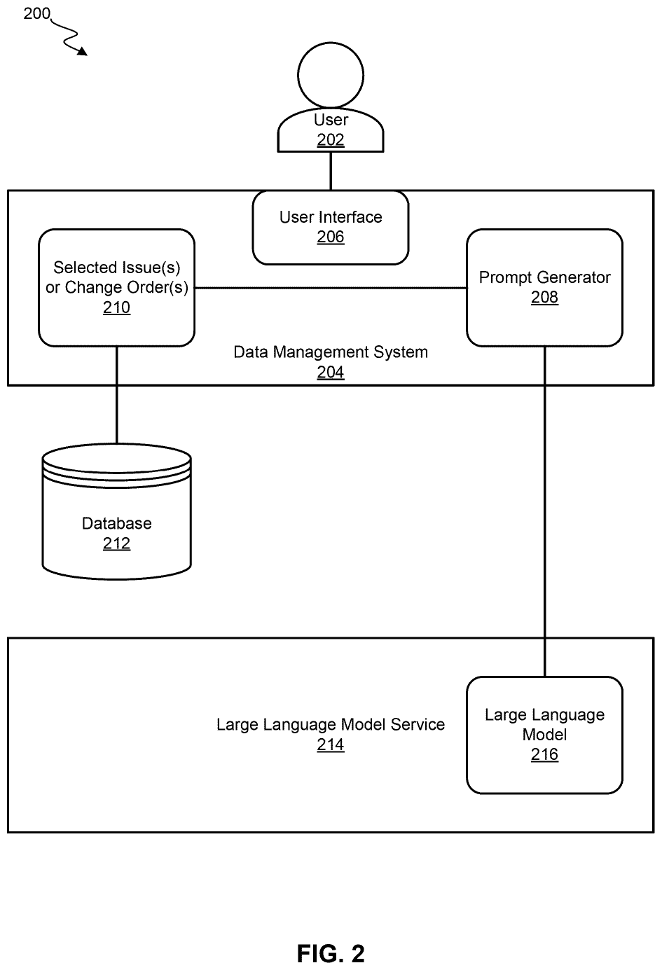

FIG. 2 illustrates a system diagram showing an example system 200 that prompts and optionally re-prompts a large language model to generate a change order based on underlying fields and/or natural language input. As shown, a user 202 interacts with a user interface 206 of data management system 204. A user may select issue(s) or change order(s) 210 based on information retrieved from database 212 via user interface 206. Upon selection of an option to generate or regenerate a change order, prompt generator 208 may embed information from selected issue(s) or change order(s) into a prompt used to prompt a large language model 216 of large language model service 214 to provide a change order. The change order may be returned to data management system 204 for review and approval by user 202 via user interface 206.

### Displaying Information Relating to Potential Change(s)

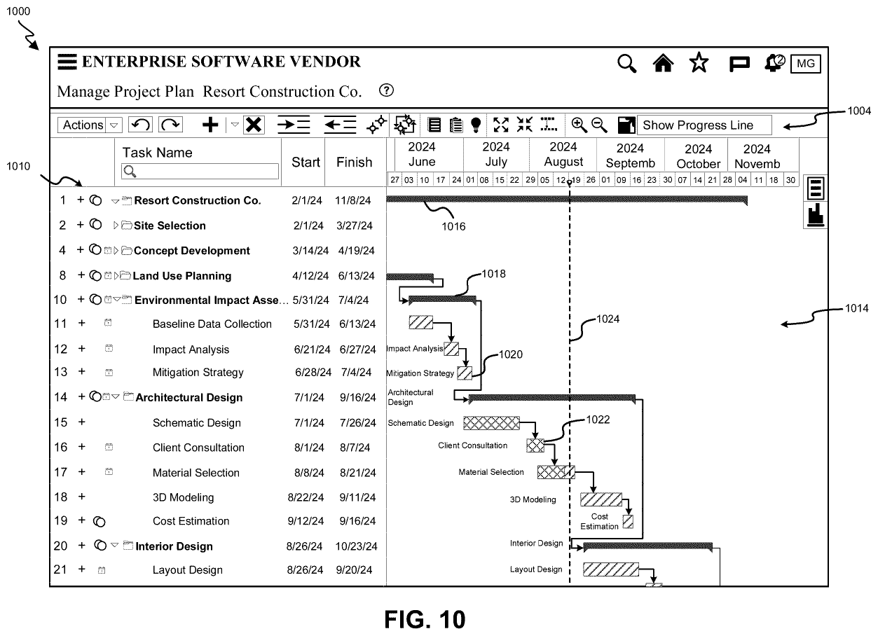

FIG. 10 illustrates a user interface 1000 showing a multi-phase project plan with different phases being completed at different times and some phases potentially overlapping with other phases. During the course of the project plan, a project manager may be tasked with maintaining up-to-date information about statuses of the different phases so that estimated start dates of other phases, estimated completion dates of the phase or other phases, or an estimated completion date for the full project may be accurately predicted. As shown in FIG. 10, the project plan may be shown in table form in region 1010 with start and finish dates and in graphical form in region 1014 showing an umbrella project duration 1016 that is overlapping with sub-project phase durations 1018, 1020, and 1022, for example. The sub-project phase durations 1018 and 1020 include overlapping bars for different potentially overlapping steps within different potentially overlapping phases. A current date or status may be indicated by progress line 1024, which may be shown or hidden using an option among tools 1004. Using interface 1000, project managers may quickly resolve tasks so minor changes in project requirements or dates do not turn into major changes in dates that cascade or snowball to impact other project dates.

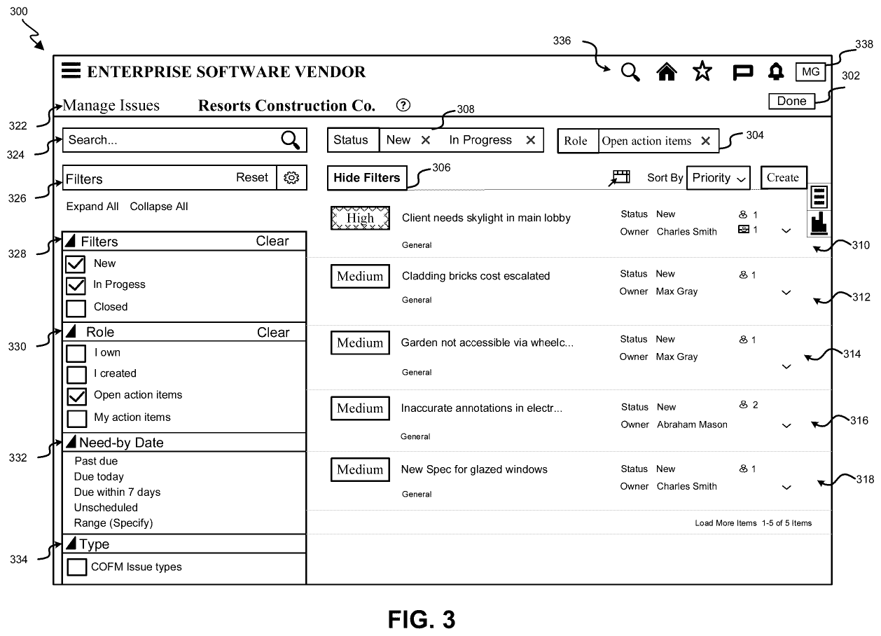

FIG. 3 shows an example user interface 300 where a User (Project Manager) is reviewing the set of issues raised for a project. As shown in the example interface 300 of FIG. 3, a plurality of potential issues 310, 312, 314, 316, and 318 are displayed for analysis. Interface 300 may be a sub-interface for managing issues for a particular client or account, such as Resorts Construction Co., as indicated in header 322. Interface 300 may include option 324 for searching issues, option 326 for filtering issues, including options 328 for selecting specific types of issues, options 330 for selecting issues or items associated with the user indicated by profile indicator 338, options 332 for selecting issues based on a need-by-date optionally in comparison with the current date of the user session, and/or other type-based filters 334 or other filters. The filters options 326, 328, 330, 332, and 334 may be hidden with the hide filters option 306. In the example, a filter has been applied to view only open action items, as indicated by role filter header 304, and only those items that are new and in progress, as indicated by status filter header 308. The issues may be scored or rated with severity or priority, for example, based on how impactful the issues could be on the project as a whole. In the example shown, issue 310 for “Client needs skylight in main lobby” is graded as a more impactful issue (“High”) than the other issues 312, 314, 316, and 318 displayed (“Medium”). FIG. 3 also shows navigational tools 336 for searching issues, returning to a home page, viewing favorite issues, viewing flagged issues or issues with action items, and/or viewing other alerts. Profile indicator 338 may indicate which user or account is authenticated in a user session for reviewing issues on interface 300.

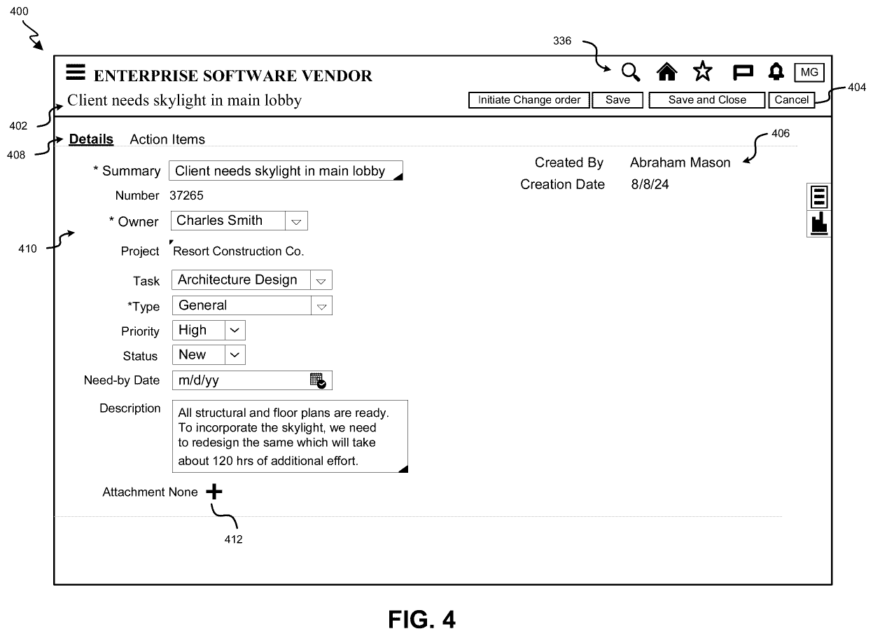

Upon selection of the high-priority issue in FIG. 3, the user interface may transition to a details page for the selected issue as shown in the example interface 400 of FIG. 4. FIG. 4 shows an example user interface 400 where a User is tasked with reviewing a particular issue which seems to be critical. Interface 400 includes a header that may include an identification of the issue 402. Details option allows details for the issue to be viewed and/or modified, and action items option allows action items for the issue to be viewed and/or modified. FIG. 4 shows example details 410 including a summary of the issue, an issue number, an owner of the issue, a project to which the issue relates, a task required, a type of task, a priority of the issue, a status of the issue, a need-by date, and a description, as well as an option 412 to add attachments. The details of the issue may be submitted by a different team member or the project manager that is reviewing the issues in interface 400. In the example shown, the issue was created by Abraham Mason, and the created by and date information are shown in region 406. The project manager is reviewing the issues and determining how to act on the issues by issuing the change order or modifying or closing the issue.

In one embodiment, a configuration interface is provided to set up a change management process at least in part by defining change participant(s), defining roles of the participant(s) on the change management process (e.g., change managers, change approvers, etc.), and defining approval configuration(s) (e.g., thresholds for auto-approvals, lower-level approvals, and higher-level approvals). In one example, the change management process may be configured based on past project data. For example, the past project data may be used to create a prediction of which change participants are responsible for reviewing or approving which kinds of change requests and storing the result of the prediction as a proposed configuration that can be modified or confirmed by an administrative user.

### Generating a Change Order

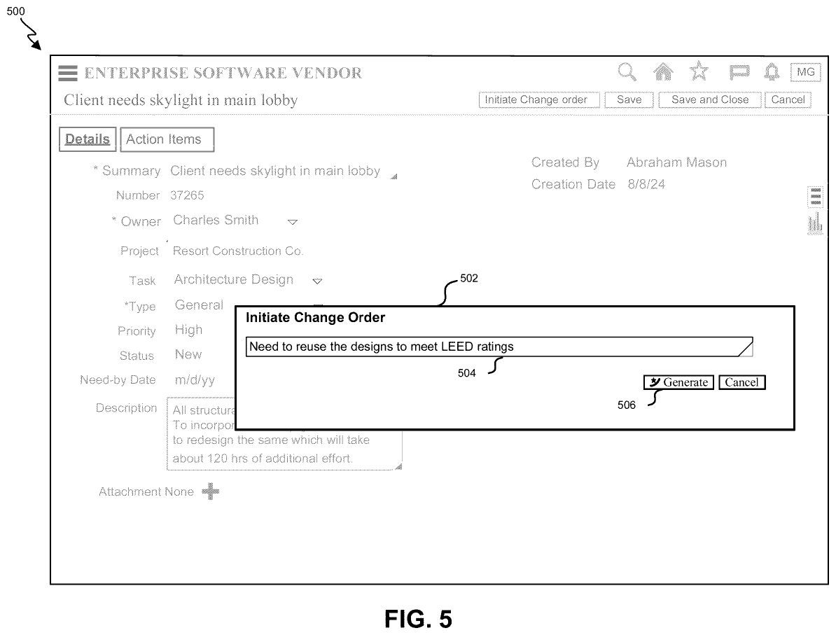

Upon review of the information in the user interface, the project manager may determine that a change order is needed for the relevant project. The example interface of FIG. 4 displays an “Initiate Change Order” button in the upper right region, which may be selected to initiate the process for creating a change order. FIG. 5 shows an example user interface 500 where a change order is initiated from natural language input. User decided to create a change order for this issue and clicks on initiate change order. User provides additional details and clicks on generate.

As shown in the example interface 500 of FIG. 5, an initiate change order overlay 502 or other interface may provide an option 504 to specify text and/or generate a proposed change order using option 506 based on the record shown in FIG. 4 and/or the specified text. When a change order is generated with a selection of the “generate” button 506, a prompt may be generated by filling in a prompt template with the details of the record shown in FIG. 4 (e.g., fields and corresponding values such as “Summary: Client needs skylight in main lobby,” “Number: 37265,” “Owner: Charles Smith,” etc.) as well as additional specified text, if any, to customize the change order. In one embodiment, details such as names or fields such as “Owner” are filtered out of or otherwise excluded from the prompt before sending to the LLM, based on a filter that detects information such as PII, private information, or other sensitive information, and prevents such information from being communicated to the LLM. In another embodiment, fields are selectively included so as to not include PII in the prompt.

In one embodiment, as shown in the Example Prompt, field names or markings may be stored in a template, and these field names or markings may serve as placeholders for the values in the template before the values are substituted for the placeholders based on the details retrieved from the record in real-time as the prompt is being generated from the template and sent to the LLM. In the example, the “Dixon Power BI Project” and “Customer Request, Design Miss, Quality Assurance, Operational Issues, Other;” are used as values from the record to substitute in place of the placeholders, {Project_Name} and {Change_Reason}, respectively. The Project Name and Change Reason are used directly to show the inputs that were provided in an example prompt. The example also shows how the prompt instructions were executed to use the Change Reason value as instructed by the relevant portion of the prompt, “Reason”: “<<Extract the change reason based on the issue details and issue type inputs and Match with the most appropriate reason only from the following list of reasons—{Change_Reason}.>>”, as the example selected “Customer Request” in the ““Reason”: “Customer Request”” output.

In other examples, the details of the record may be provided in a structured format understood by large language models, such as JSON format where fields and values are listed in pairs or any other key-value pairing format or a format that provides fields in delimited correspondence with values.

In various examples, the field values may be included in the prompt as the field values exist at the time of the change order. In another example, field values may include a history of one or more recent changes to the field values, such as a “current_priority” and “previous_priority”, to indicate how the field values are changing over time to support generation of a description of the change order that accounts for more historical information about the project.

Once generated, the change order, project details, and issue details may be visible to the company managing the project, or to select user(s) from the company. Notifications and other triggered actions may cause some information from the change order, project details, and/or issue details to be provided to other entities impacted by the change order, for example, downstream customers or affected parties. Such notifications could include details about an expected delay or adjustment in time or cost for the project, for example, and could be delivered to email addresses, phone numbers, or other contact targets associated with the impacted parties.

The change order may also trigger other reviewers and/or approvers, depending on the review and/or approval requirements for change orders satisfying certain conditions. If a reviewer or approver is required for the new change order, the reviewer or approver may be notified upon creation of the change order that the change order is stored in the system and available for viewing but has not yet been applied to change expected dates or values for the project, potentially impacting other phases. Upon review and approval or in the absence of required review and approval, the change order may be applied to the project to change project details such as expected dates or values and potentially impact other phases of the project.

In one embodiment, issues are clustered or grouped prior to initiating creation of one or more change requests that may turn into one or more change orders based on a possible many-to-many, one-to-many, or many-to-one mapping between issues and change requests, and between change requests and change orders. The clustered or grouped issues may be selected as a group to create one or more change requests or orders that account for fields and values from multiple issues. For example, the clustering may be done based on k-means clustering or using other clustering techniques on a vector embedding of each issue. In this manner, the issues closest to each other (e.g., based on cosine distance) are grouped together.

In one embodiment, a task may be identified as at risk based on predicted resource unavailability, for example, due to an issue that is raised, a change request that is stored (e.g., by a team member or a project manager), or a change order that is entered and/or approved (e.g., by a project manager or reviewer/approver). For example, the task may be identified as at risk if resources shared by the task are impacted by the change order. For example, a critical task participant going on leave may impact a project involving that participant, resulting in a change order. The critical task may be flagged when the issue is raised, even before the change order is entered, based on a probability that the change order will be approved and the critical task will be impacted (e.g., delayed) as a result. Such issues may be learned by training a machine learning model to detect issues that cause downstream delays based on characteristics of the issue and resources anticipated to be involved in the issue. Candidate change orders may be pre-created for the issue using an LLM to provide better visibility into the impacts the issue is likely to have, improving the predictive nature of the machine learning model. Also, the machine learning model may account for skill levels and types of different participants (electricians, designers, etc.) as well as non-personnel types of resources (materials, parts) that involve different skill levels and types to determine which participants might be needed to support which change orders.

In various embodiments, change orders impact participants or resources, and these impacted participants or resources may be accounted for when determining or predicting future change orders. For example, if a participant is being impacted by one change order that requires substantial work a particular day, that participant may be unavailable to be impacted by another change order that requires substantial work on the same day.

In one embodiment, a machine learning model is used to predict whether a change will be needed based on how a project is progressing. For example, tasks may be identified as driving deadlines or assigned to highly skilled labor or limited resources to determine which critical tasks may impact project progress. Problems arising or delays involving these critical tasks may be used to predict overall delays for the project and predicted change requests that may be submitted based on the delayed critical tasks or overconsumed critical resources. For example, a prior delay or pattern of delays involving the same resource may be flagged when such delays would have a critical impact on the project.

### Prompting a Large Language Model to Generate the Change Order

The large language model is prompted with the prompt, and a data structure representing a new change order may be returned from the large language model. The data structure may be consumed by the application to cause creation of the change order in the system and storage of the change order in a database.

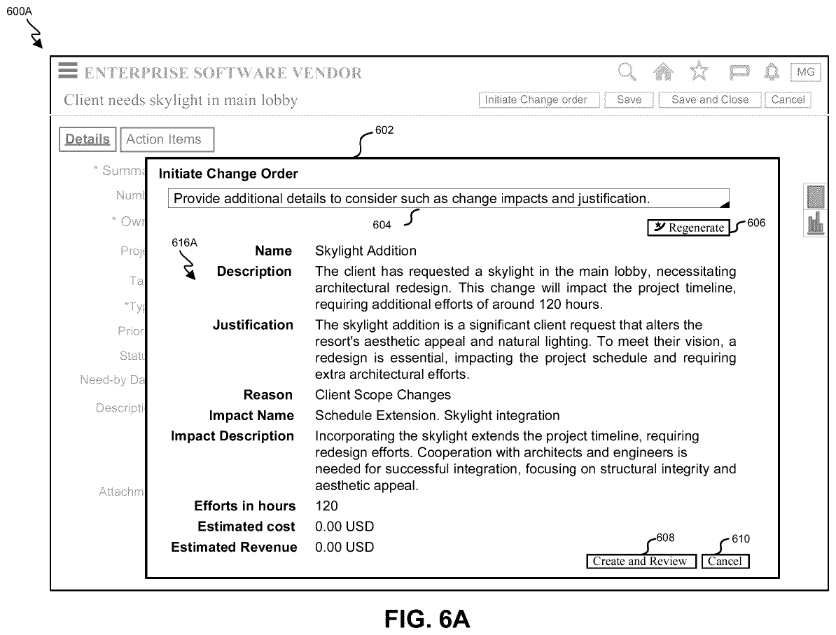

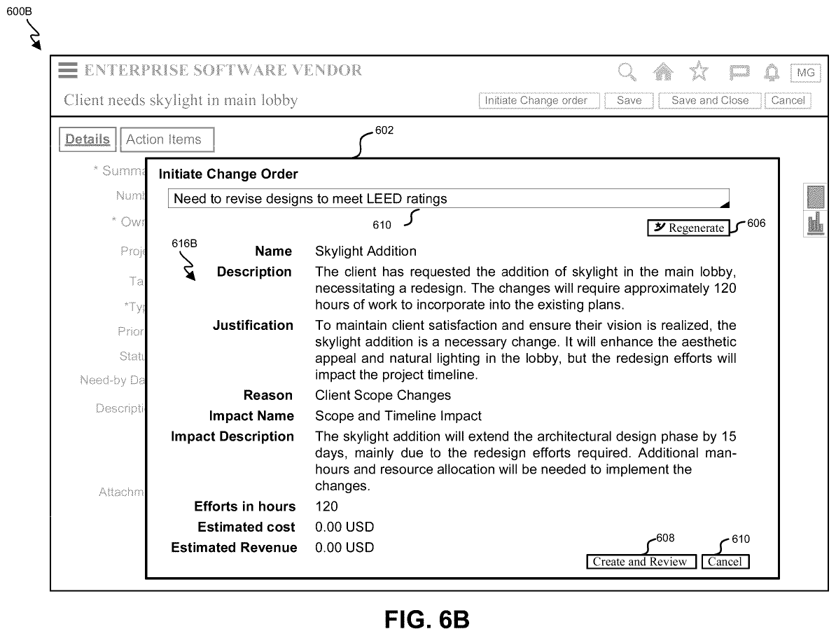

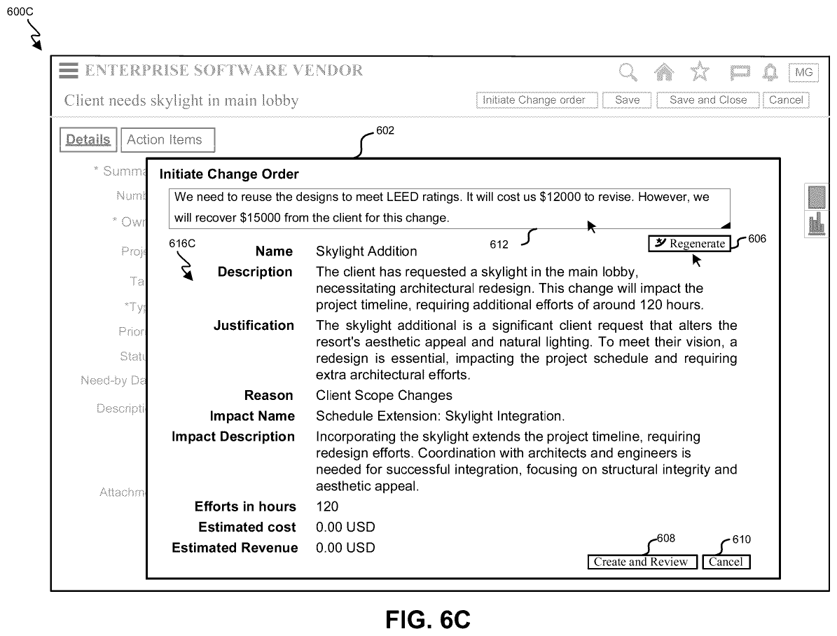

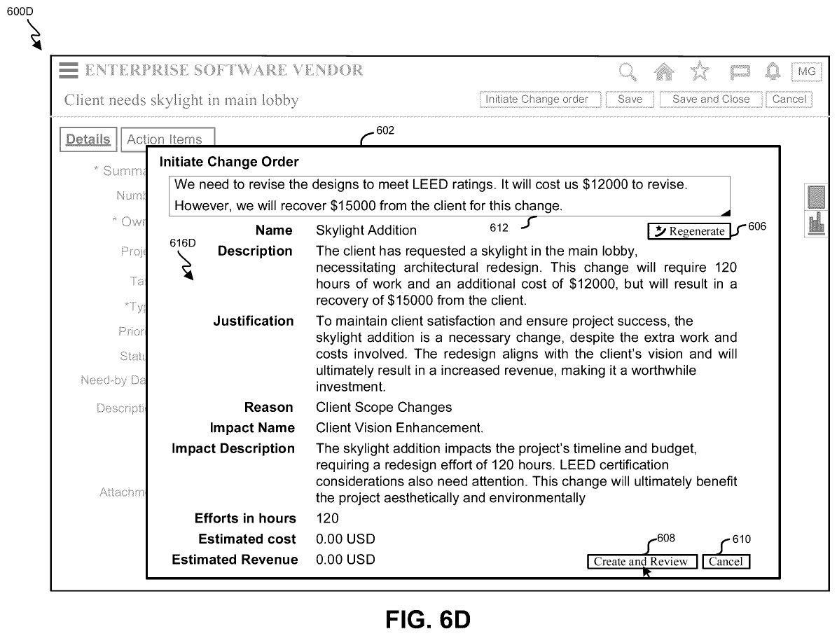

FIGS. 6A-6D show example user interfaces showing preview of generated change order(s) for user review. In various examples with reference to FIGS. 6A-6D, when prompted, the large language model may make observations about the task, such as whether the task is likely to prompt a change in schedule, how many hours the task is expected to complete, an expected cost of the change, etc. Such factors may pull in the general subject matter expertise of the large language model as applied to the facts fed into the large language model via the prompt.

In one example, a configuration command may be provided to a query processing service in a user session or connection with a client to select a particular large language model for use with the natural language of incoming queries on a user session, or for given requests, from the client. For example, the “openai” large language model provider may be chosen with named credentials. The model used may be, for example, gpt-3.5-turbo. Other example providers include, but are not limited to, Cohere, Azure AI, Google PaLM 2, Llama 3, etc. In various other examples, default credentials may be used by the query processing service. In one embodiment, the credentials include user-specific credentials, such as a user-specific inner session identifier, that allow the LLM service to switch between supporting different users within the same LLM session using the same LLM connection credentials. In this embodiment, context from a given user may be retrieved using the user-specific inner session identifier before processing a natural language query for the given user. In another embodiment, an application uses the same LLM service for users but may use different LLM sessions for different users. The LLM session may be authenticated using a token that is established to refer to a particular user session. The token may be passed by the application to establish or re-establish the authenticated session with the LLM and begin sending prompts.

In various embodiments, prompts are generated to use information about a data schema of multidimensional data available in a user session with an application. The data schema may include dimension names (e.g., Issues, Change Orders, Impacts, Parties, Projects, etc.), member names, and drill-down and roll-up hierarchies that are available to view or manipulate in the user session. The data schema may be formatted in a hierarchical format, such as JSON, XML, or another structured and delimited format that distinguishes between members at different levels of the hierarchy.

In one embodiment, the field names are passed in as information with field and value pairings that indicate what values exist for the issue or other record and/or text that is being used as input to generate the change order. The prompt may also specify the structure to use for specifying values for specific fields of a change order in the response, as well as a definition of what those specific fields mean and/or any value constraints for the fields. For example, the format for the response may be specified as JSON (e.g., an RFC8259 compliant JSON object), XML, or another structured or delimited format.

In one embodiment, the definition for specific output fields may include a placeholder for range-limiting criteria for the field, such as a list of values to choose from (e.g., comma delimited), a max value, a min value, a max length, a min length, etc. For example, in the Example Prompt, range-limiting criteria are provided as “Title_Max,” which is the maximum number of words to use in the title (10 in the examples, but this number is determined based on a user-specific or tenant-specific setting to ensure that titles meet the needs of the user or tenant), “Desc_Min,” which is the minimum number of words to use in the description (30 and 40 in different examples, to provide the LLM with information about how output might change based on variances in the range limitations), and “Desc_Max,” which is the maximum number of words to use in the description (50 and 60 in different examples, to provide the LLM with information about how output might changes based on variances in the range limitations). In the example, when Desc_Min is changed to 40 for one example, the description output of 32 words is changed to an output of 45 words to comply with the new range limitations. Providing these contrasting examples to the LLM for execution of additional prompts allows the LLM to adjust field values based on the range limitations with knowledge about how the examples might change in different scenarios.

In various embodiments, few shot examples are provided to the large language model in the prompt or in a prompt session with the large language model, such that different examples are provided with other input values and example valid output data structures determined from the other input values, formatted in a format consistent with the requested result.

Instructions may be provided to assume the role of a project manager when creating the change order, such that generated values apply domain expertise relevant to project management.

The prompts may also specify a format for providing the reply, through example valid responses to example requests, and/or through explicit description of the requested format.

In various embodiments, the techniques herein refer to “a prompt” being generated, and “the prompt” is intended to refer to a single request or multiple requests that, together, serve to prompt the LLM. LLMs may be prompted in a same session using one or multiple requests as the prompt to perform functionality, and the delineation between requests to the LLM can be split in any manner in accordance with the techniques described herein.

In one embodiment, validating the content of the LLM reply includes verifying that the reply conforms to the correct length (e.g., within an upper and/or lower threshold) and data type constraints, if any.

If the LLM reply includes a data structure consumable by the application, the validation may include verifying that the data structure conforms to a schema or set of structured instructions exposed by the application through an API.

In various embodiments, the application may provide a configuration interface to the user for configuring a workflow for handling LLM replies that could not be validated. The configuration could specify that the LLM may be re-prompted with the non-validated reply used as a non-conforming example that should be avoided, or to trigger an error message.

In one embodiment, JSON results from the LLM are parsed by searching for delimiters such as “{” and “}” or “[” and “]” in the response. The consumable JSON object may be separated from a remainder of the response for consumption by the application to create an executable structure to trigger application functionality.

In one embodiment, when using a large language model to generate one or more change requests or change orders for a cluster or group of issues, the prompt includes information about each separate issue passed in as structured data, for example, in JSON format, such that the issues are delimited from each other and the large language model is instructed to create one or more change orders to account for the issues included. In one embodiment, the large language model is allowed to determine how many change orders are represented by the group of issues. In another embodiment, the group of issues is broken into sub-groups for the large language model with an instruction to create one change order for each sub-group. In yet another embodiment, the group of issues is broken into sub-groups, and the large language model is allowed to create one or more change orders for each sub-group.

In one embodiment, rather than including separate issues or change requests, a prompt to generate one or more change orders includes a summary or aggregation of a plurality of issues or change requests. The summary may be generated by another prompt that provides, as input, values of multiple issues or change requests, such as issues or change requests in a same group, and requests a summary change request to be generated that summarizes each issue along each field. The summary may aggregate numerical values and combine textual values or descriptions together. The summary of the issues or change requests may then be provided in a new prompt to generate a change order based on the summary.

In one embodiment, an accessibility feature offered by an application allows a user to create a change order using natural language, e.g., through speech-to-text captured through a microphone, instead of clicking and typing on a screen. A proposed change order may be displayed or read aloud (as proposed fields and corresponding values, using text-to-speech), which may be further modified using natural language commands according to the change order revision features described herein. The proposed change order may further be accepted or approved, or rejected, or deleted based on natural language commands that match those user interface components. For example, the user may issue a command to “accept the change order” or “reject the change order,” and the command may cause the application to complete acceptance or rejection of the change order, accordingly, that is currently selected or shown on the user interface, or that was last read aloud to the user.

### Prompting A Large Language Model to Revise A Change Order

In the example interface 600A of FIG. 6A, a proposed change order is created from a data structure returned by the large language model, based on the information about the example issue record shown in FIG. 4 (e.g. fields and values of the record) and the additional specified text, if any, and optionally a set of predefined classification options to select for classifying the change (the selected option listed as “Reason” in FIGS. 6A-6D). The proposed change order is shown in overlay 602, along with an input option 604 to provide additional information and trigger a re-prompting and re-generating of the change order via regeneration option 606. The large language model predicts values for the fields of the change order, and the change order with the predicted values is provided to the application, for example, as a JSON-formatted or other structurally formatted result. The predicted values for the fields of the change order are shown as change order details 616A in FIG. 6A as displayed on an example user interface overlay 602 for confirmation or editing, or for triggering a regeneration of change order details by the large language model with same or different seed detail(s), which may be modified via input option 604. Options 608 and 610 cause either creation and review of the change order as detailed or cancellation of the creation of the change order. FIG. 6B shows another example interface 600B for reviewing the change order with additional details 616B added, for example, via input option 610 of FIG. 6B, or from the same or a different record or issue.

FIG. 6C shows another example interface 600C with additional user text input provided in the input region 612 of the change order preview interface. As shown, the additional user text input is a natural language expression of what should change for the initially proposed change order, reading: “We need to revise the designs to meet LEED ratings. It will cost $12000 to revise. However, we will recover $15000 from the client for this change.” Any natural language describing a desired change may be provided. This natural language detail may be inserted into a prompt template to the LLM, along with existing values for the issue (e.g., the existing summary, number, owner, etc.), previously generated value(s) of the change order identified according to their corresponding structure (e.g., values that were proposed when the regenerate button 606 was selected), an indication that the user asked to “regenerate” the change order based on the additional natural language detail, and optionally a set of predefined classification options to select for classifying the change. Change order details 616C are shown prior to regeneration of the change order details.

In a different example shown in the Example Prompt, values may be inserted into positions of the prompt template based on markings or placeholders for the values as indicated in the prompt template. For example, the placeholders may have a field name surrounded by braces, “{” and “}”, and the placeholders may be substituted for values of the fields as the prompt is generated from the prompt template. In the example, the “Dixon Power BI Project” and “Customer Request, Design Miss, Quality Assurance, Operational Issues, Other;” are used as values from the record to substitute in place of the placeholders, {Project_Name} and {Change_Reason}, respectively. The Project Name and Change Reason are used directly to show the inputs that were provided in an example prompt. The example also shows how the prompt instructions were executed to use the Change Reason value as instructed by the relevant portion of the prompt, “Reason”: “<<Extract the change reason based on the issue details and issue type inputs and Match with the most appropriate reason only from the following list of reasons-{Change_Reason}.>>”, as the example selected “Customer Request” in the ““Reason”: “Customer Request”” output.

The large language model may consume the additional prompt and regenerate the change order, which is returned as a structured object and ingested by the application to generate another preview of the resulting change order. An example of regenerated change order details is shown as 616D of FIG. 6D.

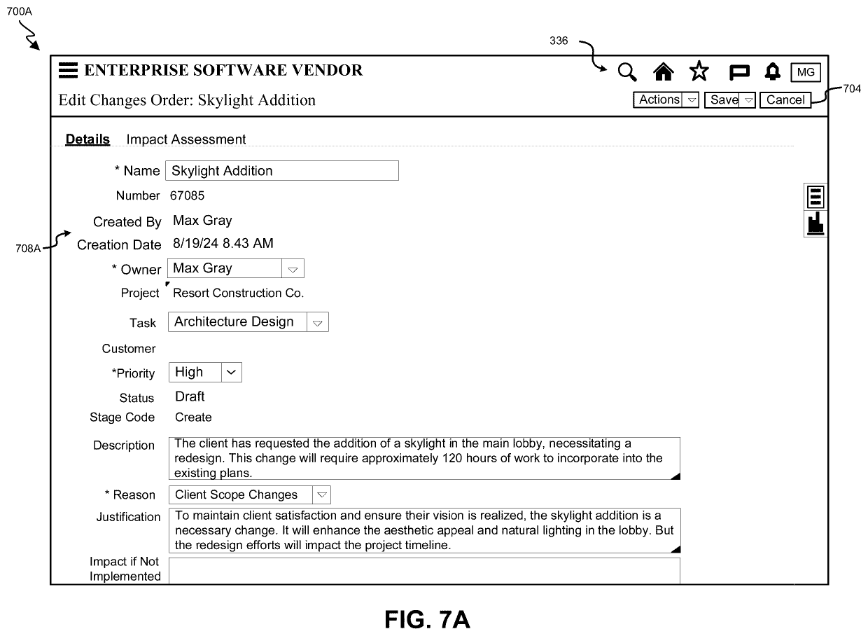

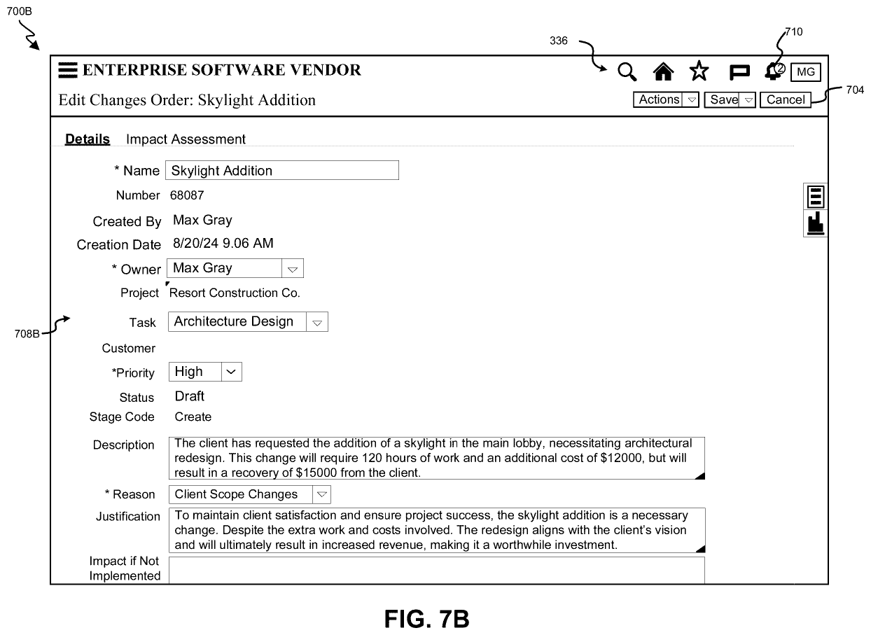

As shown in FIG. 6D, various details changed in the change order, including a mention of LEED certification, an estimated cost, and an estimated review. The additional information may be shown in a preview interface with the same regenerate and create option and cancel option as the interfaces from FIGS. 6A, 6B, and 6C. In these examples, user selection of the cancel option 610 may cancel the proposed change order previewed on the user interface without creating a new change order. On the other hand, user selection of the create and review option 608 results in creating the change order in the database and providing further options, via the user interface, for review and modification of the created change order. FIG. 7A shows an example user interface 700A displaying the created change order with options for user review, editing, and submitting the change order for approval. The example Edit Change Order interfaces 700A and 700B of FIGS. 7A and 7B show different example contents of change orders being created, and interfaces 700A and 700B support options for the user to further revise details in various fields 708A and 708B of the created change order and save results to the database. FIG. 7B has been revised already to include cost information in the description; whereas, FIG. 7A includes a revision to hours without cost information added.

### Automated Impact Assessment

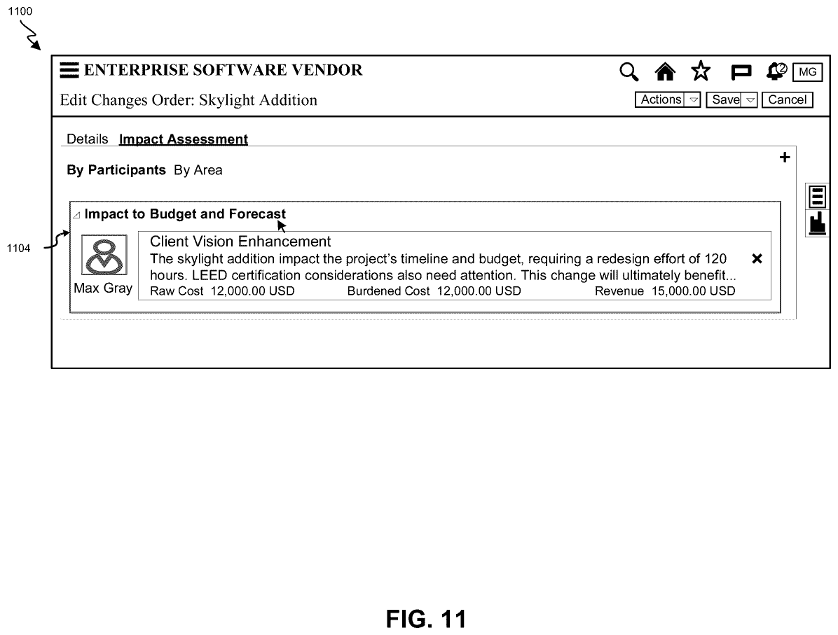

In one embodiment, the user interface includes an impact assessment tab that shows how the change impacts the project. In one embodiment, impacts are stored in association with change order(s) to indicate what impacts the change order(s) have on an organization or corresponding projects. In the example interface 1100 shown in FIG. 11, a quantified impact to budget and forecast 1104 is shown from the skylight addition example of FIG. 6D and FIG. 7B. Impacts are quantified by listing a number of hours, a monetary amount, or any other quantified result determined for the change order based on a natural language issue description. The impact may summarize how the change impacts values and times for the project as a whole. As shown, the summary indicates, “The skylight addition impacts the project's timeline and budget, requiring a redesign effort of 120 hours. LEED certification considerations also need attention. This change will ultimately benefit . . . Raw Cost: 12,000.00 USD Burdened Cost: 12,000.00 USD Revenue: 15,000.00 USD.” This summary may be generated based on the estimated cost, estimated revenue, and estimated time-to-complete, as determined by the large language model. The budget and forecast impact may be automatically created based on characteristics of the change order when the change order is created.

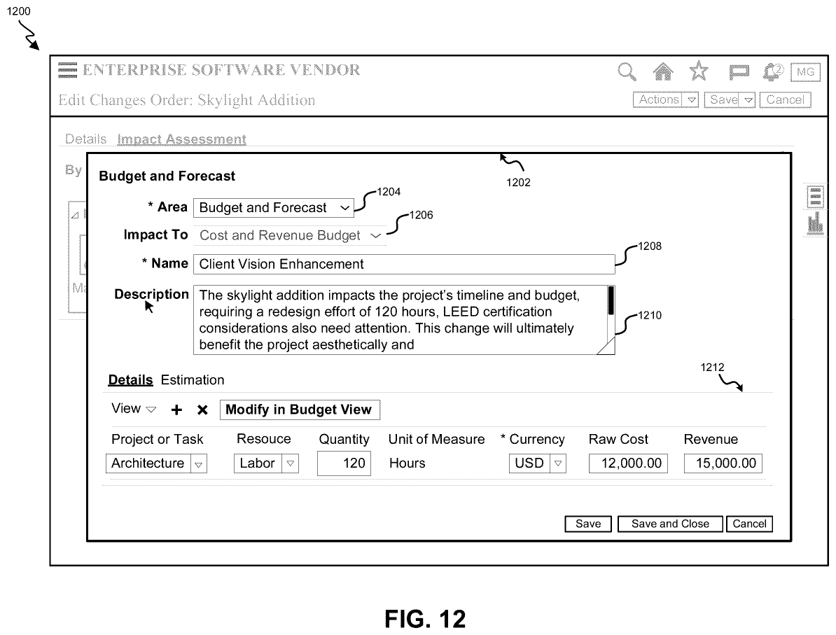

Upon selection of the budget and forecast impact, a user interface may be displayed to view details of the selected budget and forecast impact, such as the example shown in the example interface 1200 of FIG. 12. As shown, the impact area 1204 is shown as “Budget and Forecast,” and the impact is to “Cost and Revenue Budget” as indicated in field 1206. The name 1208 and description 1210 may be generated based on the change order, for example, using heuristics, machine learning, or a large language model to determine a name and description of the impact to the project in the impact area, which may be different than a name and description of the change itself and why the change was needed. Heuristics, machine learning, or a large language model may also be used to determine the project or task, resource type, quantity of hours, currency, raw cost, and revenue fields for the impact record as shown in details region 1212. For example, the task may be captured from the issue that was used to initiate creation of the change order. As another example, the Resource impacted may be determined using heuristics of whether working hours are expected to be consumed as a result of the change, in which case the change may be classified as having a labor resource impact. If only cost or revenue amounts are expected to be impacted, the change may be classified as an impact to a Financial Resources resource. In some examples, in the absence of a labor resource impact and/or in a scenario with other potential impacts, cost and bill rates may be defined in the system for computing the cost and revenue amounts. For example, the currency, raw cost, and revenue may be determined more directly from the underlying record values and/or from impact-indicating result(s) provided after analysis of the underlying record value(s) by a large language model. Details of the impact may be shown and editable in the budget and forecast interface, which may be saved if edited.

In one embodiment, if no labor resources are used for a task, a default impact may be selected based on a resource class. If labor resources are impacted, the default is selected as a Labor resource. For example, if there is impact to effort, a default is selected as Labor resource. As another example, if there is impact to cost or revenue amounts only, a default is selected as Financial resources resource.

Information extracted from the underlying record(s) and/or result(s) from the large language model may indicate whether or not manual labor, financial resources, and/or other resources are impacted by the change, and an impact may be stored in association with the change order reflecting a corresponding type of impact (labor, financial, etc.). In another scenario, if a single resource is planned for a task, a determination may be made as to whether extracted information contains effort impact. If the extracted information contains effort impact and the existing resource assignment is a labor class resource, an impact may be added to the labor class resource. If the extracted information contains effort impact and the existing resource assignment is for a non-labor resource class, an impact may be added by creating a new labor resource. If the extracted information does not contain an effort impact and there is a labor resource class or no resource class, the impact may be created as a new financial resource impact. If the extracted information does not contain an effort impact and there is a non-labor resource class, the impact may be created as an impact to the existing resource.

In another scenario, if multiple resources are planned for the task, estimates are determined based on the resource usages to determine the most likely or most significant impacts. For example, a total impact may be determined for the task, and the total impact may be broken down into proportional components based on a relative amount usage of different resources towards performance of the task. For example, 60% of the task may be attributed to usage of a first resource and 40% to usage of a second resource, and a 100-hour total effort impact, as predicted by an LLM based on information about a change, may be broken up into 60 hours of the first labor resource and 40 hours of the second labor resource, for labor resources assigned to the task. In another example, 70% of a $10,000 financial impact may be attributed to a first resource, and 30% of a $10,000 financial impact is attributed to a second resource. In this example, $7,000 is attributed to the first resource and $3,000 is attributed to the second resource, for different resources assigned to the task.

The relative percentages may be estimated based on historical data or other previously stored data and/or based on information retrieved from an LLM about relatively how much of the task would be accomplished or attributed to different available resources. The estimate may be based on an LLM response that accounts for metadata about the resources as provided to the LLM based on information already stored in association with the resources, and/or based on an agent that consumes a result of the LLM and uses the metadata to allocate a result of the LLM to different resources. Some of the metadata may be previously known and stored in association with the resources, and other metadata may be determined by the LLM based on other information known about the task, resources, and/or a history of tasks and/or resources used. The metadata may include information about a dependency or dependencies that exists between the task and one or more resources, about how fast, accurately, or efficiently different labor resources operate (for example, as applicable to the type(s) of task(s) involved in the change order), expertise or different skill(s) or skill level(s) of different labor resources (for example, as applicable to the type(s) of task(s) involved in the change order), cost rate (e.g., hourly cost) of different labor resources, availability of different labor or financial resources (for example, available at a time specified for the tasks involved in the change order), and/or how much those resources are already impacted, positively or negatively, by the task. In a particular example, an agent may apply heuristics to determine which resources to select based on a combination of criteria included in the metadata. For example, a business unit carrying 30% of the benefit from the project may have 30% of the expense (e.g. airfare, meals, or other expenses) attributed to it. These percentages may be customized based on business needs for different resources impacted by task performance.

In one embodiment, impacts may be provided by the LLM according to a format specified to the LLM that does not require specific amounts to be disclosed to the LLM. For example, a contracted amount of the project, $200,000, may be impacted by a 20% discount. The LLM may determine that a 20% discount is being given and specify a financial impact of −0.2*A, where A is the contracted amount of the project. An agent may consume the result provided by the LLM and substitute $200,000 for A, to result in a financial impact of −$40,000. In order to get the LLM to specify a formula with the correct placeholders, the agent may prompt the LLM to use certain placeholders for certain values, and to specify functions with certain delimiters or within a certain data structure, so that the functions may be consumed and evaluated by the agent upon reply by the LLM.

In another example, impacts may be provided as absolute impacts, relative impacts, or a combination thereof. In this example, the LLM may have a designated structure for returning the relative impacts separately from absolute impacts, such that a 20% discount may be specified as −0.2 under a relative cost impact variable that is determined and returned separately from the absolute impact variables. The LLM may be instructed to use the relative impact variables instead of the absolute impact variables when absolute impacts cannot be determined based on the information provided but when relative impacts are known, for example, in terms of percentages. An agent may be configured to consume the relative financial impact amounts and apply them to the total financial impact of the project, to determine a financial impact of −0.2*200,000=−$40,000.

In yet another example, an effort impact may be specified as a relative impact. In this example, the LLM may specify the effort impact as +0.25 or +0.25 L for a relative effort impact of 25% more labor on a 1,000-hour project. The effort impact may be determined by the LLM and consumed by an agent that is configured to determine the absolute impact based on the total effort of the project, 1,000 hours in this case, which may or may not have been provided to the LLM. In this example, the agent would consume a relative effort impact of +0.25 and multiple by 1,000 hours to get an absolute effort impact of +250 hours.

In another embodiment, values from the impact may be determined using a machine learning model. For example, values that have been selected for impacts in the past, optionally with user input, and based on past values for corresponding issue record(s) and/or change record(s) (e.g. description, cost, revenue, and hours values) may be used as training data to predict unknown values based on the corresponding values in issue record(s) and/or change record(s). The machine learning model may alternatively or additionally be used to determine impacts in impact areas other than budget and forecast impacts, such as contracts, project plans, requirements, resources, etc.

In one embodiment, multiple impacts may be generated from a single change order or from multiple change orders created together based on a single issue or change request or a group of issues or change requests. The multiple impacts may be stored separately, indicating different impact areas that result from the change order(s).

In one embodiment, creation of one impact may cause one or more stored conditions to be evaluated and, if satisfied, cause creation of another impact. For example, a time delay may not be caused if worker hours are available to resolve an issue on the same day an issue is raised. In this scenario, a worker impact may be first created. Then, if the worker hours are not available, a scheduling impact may occur. As another example, a budget impact may cause a change to a contract, resulting in a contract impact. Impacts may be chained together, and information may be stored for each impact as to which other change order or impact triggered the impact.

### AI-Assisted Project Change Order Generation Examples

Various embodiments use generative AI based on an underpinning Large Language Model (LLM) to automate project change order generation. For example, for project issues that use a change order, the LLM uses the information available in the issue, project, and other sources to generate the change order. The solution involves the use of generative AI for extraction, classification, and generation to create the change order. The generated change order includes a wide variety of information, including the summary of the changes, the justification for the changes and budget impact assessments. Users often spend excessive time entering details that already exist in the system, leading to redundant efforts and a poor user experience. Various embodiments reduce a significant amount of administrative effort while working with enterprise applications and maintain information security as, in one embodiment, data does not leave the enterprise systems.

Effective change management is useful for project legal and profitability risk management and in identifying lessons learned for future endeavours. Addressing pertinent project issues through change management significantly contributes to risk mitigation. A project manager may document the issue as a change request which involved manually filling out a form. Project managers may meticulously capture extensive details of the change including the description, justification, reason, estimated amount of impact on the costs and billing amounts as they impact the contract terms. Moreover, in large scale projects multiple issues may be consolidated into a single change request, and multiple change requests may be consolidated into a single change order which further compounds this challenge and would take several minutes to an hour with natural limitations in accuracy, efficiency, completeness, and integration of existing knowledge in the manner of completion. This time-consuming task diverts project managers' attention from strategic priorities, particularly for the project managers who typically operate under tight deadlines and juggle with multiple tasks and projects simultaneously. On-site project managers also face difficulties in inputting data due to limited access and hinderances. Furthermore, form-based systems are cumbersome for users with visual impairments who rely on screen readers.

Various embodiments described herein leverage large language models (LLMs) to automate the generation of a draft change request or change order, significantly reducing the time project managers spend on this task. Example custom designed prompts take the following types of input: the project issues data, pre-defined choices of Change Reason for classification of the change, and optional details provided by the user in natural language as additional context. Specific instructions are provided to let the LLM use this information to generate the information requested in a structured format enabling direct consumption by other APIs to create a change request or change order.

The data management system may offer users the option to regenerate responses to help them find a suitable version. The prompt parameters may be fine-tuned to balance variety and accuracy in the regenerated responses. Additionally, the data management system provides the user the flexibility to make edits to the generated content before saving the generated content. The techniques described herein may reduce and avoid a significant amount of administrative effort while giving users control by performing tasks in a different manner that relies on the system architecture including the LLM, the underlying record, prompt templates, and/or stored heuristics.

Example benefits may include, but are not required of the techniques or limiting to the techniques unless otherwise specified:
1. Efficient change management
   a. The user does not have to type out information in a form, one field at a time. The user can simply choose to enter text in natural language such as “Prepare a change order for additional plumbing work in the south wing, increase budget by $5,000, and extend completion by one week.” The LLM may instantly process this input within the context of the project and will generate a change order prefilled with all the relevant details. The user can simply review the details and submit the change order for next steps. Users who predominantly work on site with limited access to laptops or computer systems with larger screens and full keyboard capabilities may generate change orders without the benefit of these other interactive computer technologies. Various features described herein may also improve accessibility for users with visual impairments who rely on screen readers, as traditional form entry can be challenging.
2. Accurate impact assessment
   a. Change requests or change orders may eventually impact the project budget amounts. The data management system extracts this information from the input data and map the impact to the right resource assignment on the project budget whenever possible. This is achieved based on the resource class of the existing assignments on the project budget. For example, if the impact is an increase in effort, the data management system maps that impact to a Labor resource assignment for the task on the project budget. With this level of detail captured in the change request or change order, after approvals, the project budget can be updated with the accurate up-to date information in single click and in a manner that robustly accounts for all potentially relevant information.
3. Graceful degradation to handle data inconsistencies
   a. When creating a change order or request, the data management system may extract and capture maximum detail to automate budget updates. However, data inconsistencies like missing rates or unhandled errors can hinder this process. In such cases, the data management system falls back to creating the change order with only the estimated impact numbers. With the core of the change order already in place, the project manager can supplement the missing information preventing recreation of change orders from scratch.
4. Quick response times with simultaneous operations
   a. Extraction, classification, and authoring may no longer be treated as separate problems with custom models being used for individual tasks. Avoiding these custom models and separate workflows avoids potential for errors and increased latency. In various embodiments, the data management system leverages the capabilities of LLM to do these tasks simultaneously.
5. Customization of responses
   a. Techniques described herein allow the product teams to adjust specific parameters within the input, giving more control over the model's output without the need for modifying the core prompt or even knowledge of the architecture and complexity of the prompt template or the constraints specified therein. This also lays the ground work for providing this control at end-user level allowing flexibility for customers to meet their specific requirements.
   Out of the box, the data management system may predefine parameters such as the length of the descriptive texts. However, if the customers would like the model to generate concise texts, they could choose to provide the new expected lengths without being exposed to the complexity of the prompt template itself or endangered by the risks of modifying such a complex data object.
6. Evaluation metrics for maintaining quality
   a. To guarantee that the data management system gets suitable responses as the LLM is updated over time, the data management system has implemented a robust evaluation framework. This involves evaluating the responses against a set of tailored metrics to monitor the model performance.

For end customers, various embodiments described herein save significant time that may otherwise be consumed in using enterprise applications daily. The new user experience of providing text in natural language to generate the change order also greatly benefits users who depend on screen readers, making their tasks much easier.

Moreover, professionals using LLMs risk exposing sensitive data. However, various embodiments built on Oracle's technology stack or other proprietary systems may ensure data stays within enterprise system boundaries, allowing customers to leverage LLMs' power without compromising security.

From the enterprise application service provider perspective, if the data management system leverages pre-trained models, there may be a cost advantage as in-house training and specialized development is eliminated.

If hallucinations occur, impacts can be mitigated with a human in the loop, along with several levels of validation, to prevent or correct errors.

The model is probabilistic but able to handle a majority of the work, significantly easing the overall effort required.

In various embodiments described herein, GenAI is leveraged for converting an issue to a change request or change order

Data from the primary object, along with optional supplementary input, may be sent to a custom engineered prompt. This prompt is designed to the extract key information, perform classifications and subsequently generate response in a structured format. The response undergoes parsing and validation checks before calling existing APIs to create the downstream business object.

For example, to create a change order from a project issue, the data management system uses the information available in the issue such as the project task, issue description, issue type as the primary source of information. The data management system also sends the user entered information which serves as additional context for the model and the set of possible values for the change reason attribute where the data management system may perform classifications.

These features may be related in various embodiments to a project change management offering within Fusion Project Management Cloud or another project management cloud offering.

The data management system may help project managers quickly create a change order or change request by generating a draft with sufficient details based on the existing information captured in the system.

Without the techniques described herein, creating a change order or change request may be a manual and inefficient process, requiring duplicate data entry with inconsistent and incomplete results due to the different manner that data is provided and handled in the manual route. The data management system may assemble information from various project issues to compile a change request or consolidate multiple change requests into a change order. Attempting this time-consuming task may divert project managers' attention from strategic priorities, and may result in inconsistencies or incompleteness due to the limitations inherent of project managers. These limitations are compounded for the project managers who typically operate under tight deadlines and juggle with multiple tasks and projects simultaneously.

The data management system described herein leverages GenAI to create the draft of a change request or change order. The draft may be created in phases, including, for example:
1. User Request: The project manager initiates a change order from the context of an issue that's raised in the system. The user can also optionally provide additional specific details that are requested to be captured in the change order in a free-form text.
2. GenAI model: Generates a draft of the change request/change order in a structured format including an extract of impact on effort, cost, and revenue for downstream processing.
3. Post Processing: Based on the specific data scenario such as whether a baseline budget exists or not and based on the existing resource assignments for a particular task, the extracted effort, cost and revenue impacts are mapped to appropriate resource assignments.

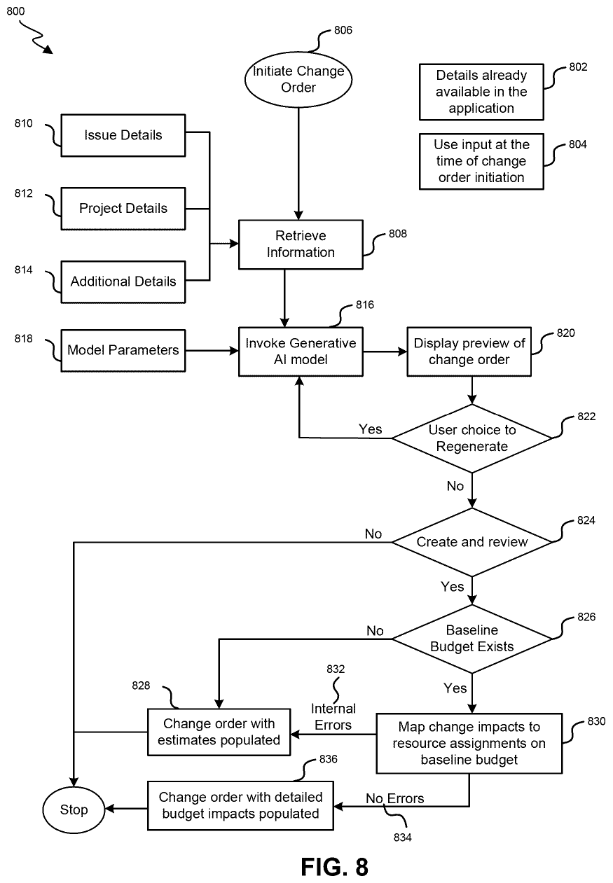

FIG. 8 illustrates a flow chart of an example process 800 for creating and reviewing a change order using generative artificial intelligence. As shown, process 800 uses details already available in the application 802, and uses input at the time of change order initiation 804. The change order is initiated in block 806, resulting in information being retrieved in block 808. Example retrieved information includes issue details 810, project details 812, and additional details 814. A generative AI model is invoked in block 816, which uses model parameters 818 and results in display of a preview of a change order in block 820. A user option or choice to regenerate is available in block 822. Upon regeneration, process 800 returns to block 816 to invoke the generative AI model. Otherwise, process 800 continues to block 824 to a user option to create and review the change order. If the option is taken, a determination is made as to whether baseline budget exists in block 826. If so, change impacts are mapped to resource assignments on baseline budget in block 830, with any internal errors 832 feeding back to determine a change order with estimates populated. If there are no errors in block 830, as indicated by “no errors” path 834, the change order with detailed budget impacts is populated in block 836. If a baseline budget does not exist from block 826, the change order with estimates populated is determined directly in block 828.

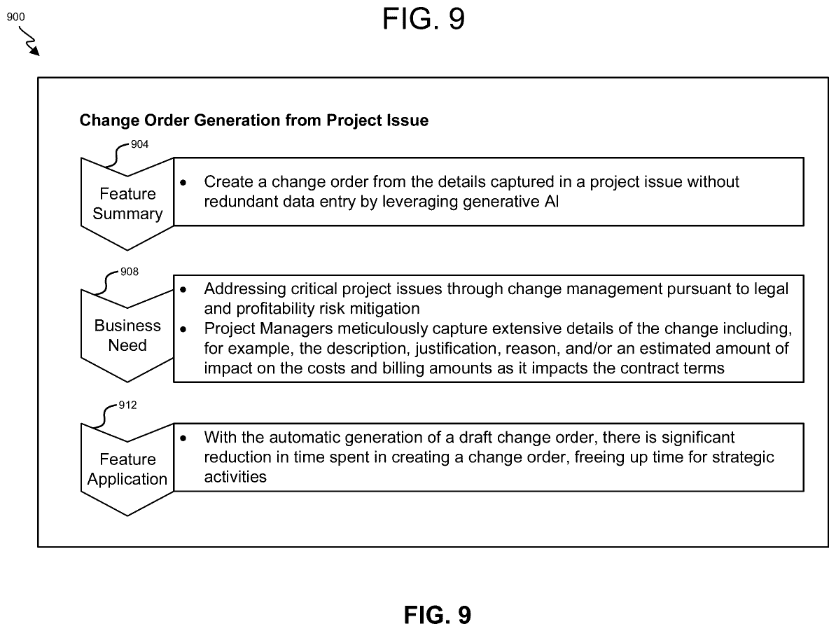

FIG. 9 illustrates an example workflow 900 of creating change orders to address issues. As shown, workflow 900 includes feature summary phase 904 where a change order is created from the details captured in a project issue without redundant data entry by leveraging generative AI. Workflow also includes a business need phase 908 for addressing critical project issues through change management pursuant to legal and profitability risk mitigation. Phase 908 also includes project managers meticulously capturing extensive details of the change including, for example, the description, justification, reason, and/or an estimated amount of impact on the costs and billing amounts as it impacts contract terms. Phase 912 includes application of the feature. With the automatic generation of a draft change order, there is a significant reduction in time spent in creating a change order, freeing up time for strategic activities.

### Example Prompt

An example prompt is provided, and the example prompt includes further examples within the prompt to show the LLM examples of how to generate the output based on a variety of inputs.

### Example Prompt

## Information:
Project Name: {Project_Name} ;
Issue Name: {Issue_Summary} ;
Issue Description: {Issue_Description};
Issue Type: {Issue_Type};
Issue Priority: {Issue_Priority};
Task Name: {Task_Name};
Additional context: {Add_Context};
## Instructions:
Assume the role of a project manager, distinguished for documenting project changes and
communicating the same with stakeholders. Your current assignment involves creating a
change order, drawing on the provided references. If the information provided contains
information not relevant or is inappropriate for workplace, ignore the information while
generating the response.
Provide the response in RFC8259 compliant JSON object in the following format:
{
“Name” : “<<Provide a short description of the change using a maximum of {Title_Max}
words >>”.
“Reason” : “<<Extract the change reason based on the issue details and issue type inputs and
Match with the most appropriate reason only from the following list of reasons -
{Change_Reason}.>>”,
“Description” : “<<Write a description of the change order. Include a brief summary of the
issue and the impact of the change on project budget and timelines if any. Use a minimum of
{Desc_Min} words>> ”,
“Justification” : “<<Based on the Reason Extracted, Issue Description, and Issue Type,
explain why the change order is necessary. Use a minimum of {Desc_Min} words and
maximum of {Desc_Max} words>>”,
“ChangeImpactSummary” : “<<Provide an appropriate name for the change impact. Use a
maximum of {Title_Max} words>>”,
“ChangeImpactDescription” : “<<Generate the details of the impact to the project because of
this change. Include details on the potential next steps to be performed to address the change.
Use minimum of {Desc_Min} words and maximum of {Desc_Max} words> >>”,
“EffortsInHours” : “<<Extract effort impact information from Additional context and/or Issue
Description as an integer value. Remember that a day is equal to 8 hours. You must return 0
if not available.>>”,
“EstimatedCost” : “<<Extract cost impact information from Additional context and/or Issue
Description as an integer value. You must return 0 if not available. >>”,
“EstimatedRevenue” : “<<Extract revenue impact information from Additional context
and/or Issue Description as an integer value. You must return 0 if not available. >>”
}
## Examples:
Project Name: Dixon Power BI Project;
Issue Name: Additional legacy system data partitioning required.;
Issue Description: I need 40 hrs to build additional data partitioning to meet the customer
internal security needs. This enhancement request was raised during the demo.;
Issue Type: Scope Creep;
Issue Priority: High;
Task Name: Security Architecture;
Additional context: This will impact project delivery timescales.;
Change_Reason: Customer Request,Design Miss,Quality Assurance,Operational
Issues,Other;
Title_Max: 10;
Desc_Min: 30;
Desc_Max: 50;
Change Order:
{
“Name” : “Enhanced Data Partitioning”,
“Reason” : “Customer Request”,
“Description” : “Additional data partitioning is required due to customer's internal security
needs, which will take 40 hours of work. This was identified during the demo as a high-
priority enhancement, impacting the project timeline.”,
“Justification” : “The additional data partitioning is crucial to address the customer's security
requirements. It is a necessary change to ensure the project aligns with their expectations and
maintains a high level of data protection.”,
“ChangeImpactSummary” : “Security Partitioning Impact”,
“ChangeImpactDescription” : “Additional 40 hours needed for redesigning the security
architecture for finance team data partitioning. Extra budget required for increased
development time and resource allocation.”,
“EffortsInHours” : 40,
“EstimatedCost” : 0,
“EstimatedRevenue” : 0
}
Project Name: Highway Construction;
Issue Name: Poor Road Surface Quality;
Issue Description: The newly constructed road surface has developed cracks and uneven
areas, compromising its durability and safety.;
Issue Type: Quality;
Issue Priority: Medium;
Task Name: Surface Pavement;
Additional context: poor road surface quality could lead to safety hazards, increased
maintenance costs, and potential legal liabilities.;
Change_Reason: Customer Request,Design Miss,Quality Assurance,Operational
Issues,Other;
Title_Max: 10;
Desc_Min: 30;
Desc_Max: 50;
Change Order:
{
“Name” : “Resurface Highway”,
“Description” : “The newly laid road surface has quality issues, necessitating removal and
replacement to ensure safety and longevity. This change will impact the project timeline and
budget, requiring additional materials and labor.”,
“Reason” : “Quality Assurance”,
“Justification” : “The current road surface has cracks and unevenness, which could pose
safety risks and lead to premature deterioration. To maintain project quality, a re-pave is
necessary, focusing on thorough material preparation and compaction for a smooth, durable
finish.”,
“ChangeImpactSummary” : “Budget Impact: Resurface Highway”,
“ChangeImpactDescription” : “The resurface work will extend the project timeline by two
weeks and incur extra costs for materials and labor. Additional inspection efforts will also be
required to oversee the repairs.”,
“EffortsInHours” : 0,
“EstimatedCost” : 0,
“EstimatedRevenue” : 0
}
Project Name: Dixon Power BI Project;
Issue Name: Additional legacy system data partitioning required.;
Issue Description: I need 40 hrs to build additional data partitioning to meet the customer
internal security needs. This enhancement request was raised during the demo.;
Issue Type: Scope Creep;
Issue Priority: High;
Task Name: Security Architecture;
Additional context: This will impact project delivery timescales.;
Change_Reason: Customer Request,Design Miss,Quality Assurance,Operational
Issues,Other;
Title_Max: 10;
Desc_Min: 40;
Desc_Max: 60;
Change Order:
{
“Name” : “Enhanced Data Partitioning”,
“Reason” : “Customer Request”,
“Description” : “Additional data partitioning is required due to customer's internal security
needs, which will take 40 hours of work. This was identified by the customer during a demo
as an enhancement request with high priority, and the request is expected to impact the
project delivery timeline.”,
“Justification” : “The additional data partitioning is crucial to address the customer's security
requirements. It is a necessary change to ensure the project aligns with their expectations and
maintains a high level of data protection.”,
“ChangeImpactSummary” : “Security Partitioning Impact”,
“ChangeImpactDescription” : “Additional 40 hours needed for redesigning the security
architecture for finance team data partitioning. Extra budget required for increased
development time and resource allocation.”,
“EffortsInHours” : 40,
“EstimatedCost” : 0,
“EstimatedRevenue” : 0
}
Remember to return 0 for EffortsInHours, EstimatedCost, and/or EstimatedRevenue if the
data is not available in the inputs.
Also, make sure that the word count for Justification is between {Desc_Min} to
{Desc_Max}.

### Computer System Architecture

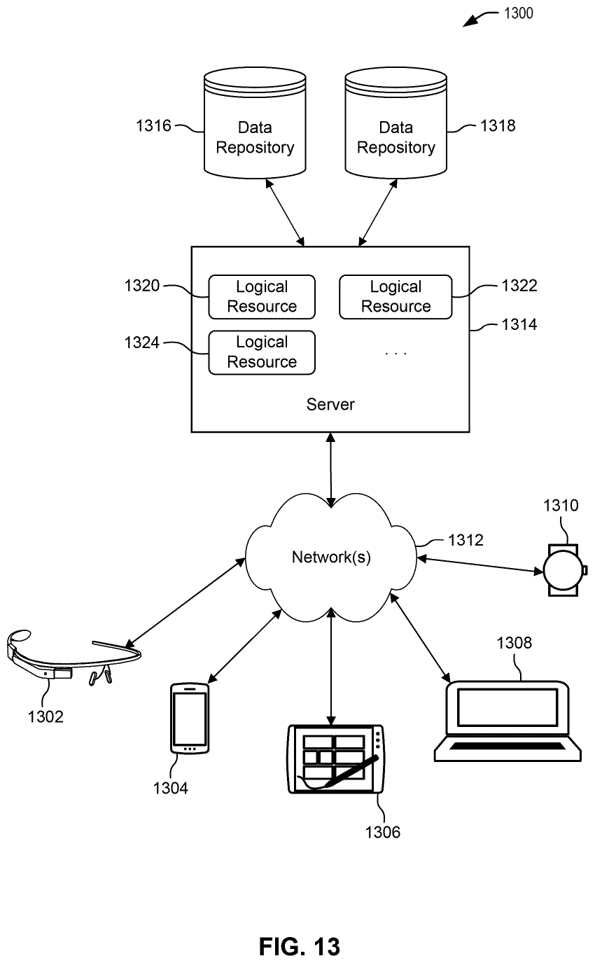

FIG. 13 depicts a simplified diagram of a distributed system 1300 for implementing an embodiment. In the illustrated embodiment, distributed system 1300 includes one or more client computing devices 1302, 1304, 1306, 1308, and/or 1310 coupled to a server 1314 via one or more communication networks 1312. Clients computing devices 1302, 1304, 1306, 1308, and/or 1310 may be configured to execute one or more applications.

In various aspects, server 1314 may be adapted to run one or more services or software applications that enable techniques for prompting and optionally re-prompting a large language model to generate a change order based on underlying fields and/or natural language input.

In certain aspects, server 1314 may also provide other services or software applications that can include non-virtual and virtual environments. In some aspects, these services may be offered as web-based or cloud services, such as under a Software as a Service (SaaS) model to the users of client computing devices 1302, 1304, 1306, 1308, and/or 1310. Users operating client computing devices 1302, 1304, 1306, 1308, and/or 1310 may in turn utilize one or more client applications to interact with server 1314 to utilize the services provided by these components.

In the configuration depicted in FIG. 13, server 1314 may include one or more components 1320, 1322 and 1324 that implement the functions performed by server 1314. These components may include software components that may be executed by one or more processors, hardware components, or combinations thereof. It should be appreciated that various different system configurations are possible, which may be different from distributed system 1300. The embodiment shown in FIG. 13 is thus one example of a distributed system for implementing an embodiment system and is not intended to be limiting.

Users may use client computing devices 1302, 1304, 1306, 1308, and/or 1310 for techniques for prompting and optionally re-prompting a large language model to generate a change order based on underlying fields and/or natural language input in accordance with the teachings of this disclosure. A client device may provide an interface that enables a user of the client device to interact with the client device. The client device may also output information to the user via this interface. Although FIG. 13 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon®) Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 1312 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 1312 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 1314 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 1314 can include one or more virtual machines running virtual operating systems, or other computing architectures involving virtualization such as one or more flexible pools of logical storage devices that can be virtualized to maintain virtual storage devices for the server. In various aspects, server 1314 may be adapted to run one or more services or software applications that provide the functionality described in the foregoing disclosure.

The computing systems in server 1314 may run one or more operating systems including any of those discussed above, as well as any commercially available server operating system. Server 1314 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 1314 may include one or more applications to analyze and consolidate data feeds and/or event updates received from users of client computing devices 1302, 1304, 1306, 1308, and/or 1310. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1314 may also include one or more applications to display the data feeds and/or real-time events via one or more display devices of client computing devices 1302, 1304, 1306, 1308, and/or 1310.

Distributed system 1300 may also include one or more data repositories 1316, 1318. These data repositories may be used to store data and other information in certain aspects. For example, one or more of the data repositories 1316, 1318 may be used to store information for techniques for prompting and optionally re-prompting a large language model to generate a change order based on underlying fields and/or natural language input. Data repositories 1316, 1318 may reside in a variety of locations. For example, a data repository used by server 1314 may be local to server 1314 or may be remote from server 1314 and in communication with server 1314 via a network-based or dedicated connection. Data repositories 1316, 1318 may be of different types. In certain aspects, a data repository used by server 1314 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 1316, 1318 may also be used by applications to store application data. The data repositories used by applications may be of different types such as, for example, a key-value store repository, an object store repository, or a general storage repository supported by a file system.

In one embodiment, server 1314 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

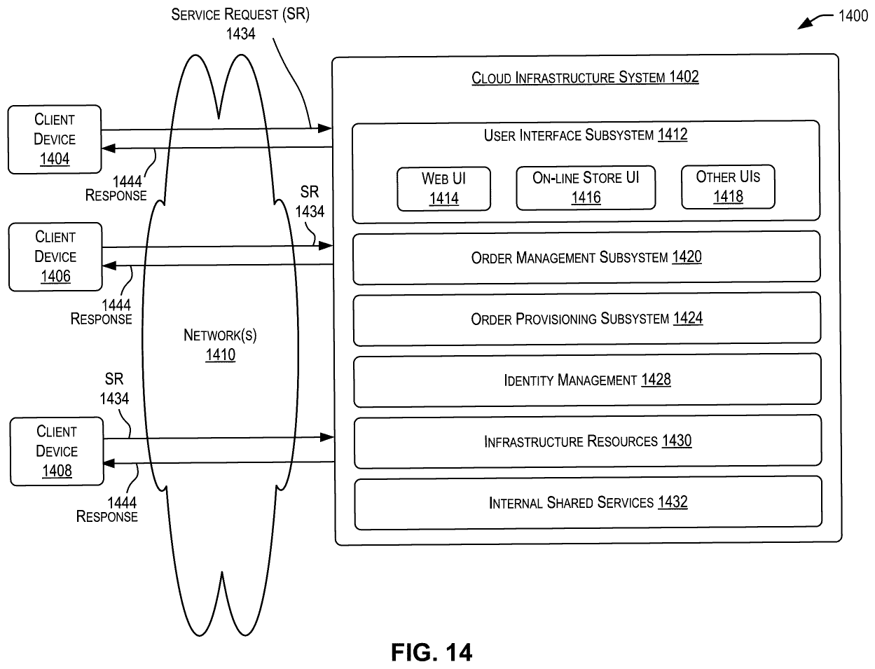

FIG. 14 is a simplified block diagram of a cloud-based system environment in which a large language model is prompted and optionally re-prompted to generate a change order based on underlying fields and/or natural language input, in accordance with certain aspects. In the embodiment depicted in FIG. 14, cloud infrastructure system 1402 may provide one or more cloud services that may be requested by users using one or more client computing devices 1404, 1406, and 1408. Cloud infrastructure system 1402 may comprise one or more computers and/or servers that may include those described above for server 1314. The computers in cloud infrastructure system 1402 may be organized as general purpose computers, specialized server computers, server farms, server clusters, or any other appropriate arrangement and/or combination.

Network(s) 1410 may facilitate communication and exchange of data between clients 1404, 1406, and 1408 and cloud infrastructure system 1402. Network(s) 1410 may include one or more networks. The networks may be of the same or different types. Network(s) 1410 may support one or more communication protocols, including wired and/or wireless protocols, for facilitating the communications.

The embodiment depicted in FIG. 14 is only one example of a cloud infrastructure system and is not intended to be limiting. It should be appreciated that, in some other aspects, cloud infrastructure system 1402 may have more or fewer components than those depicted in FIG. 14, may combine two or more components, or may have a different configuration or arrangement of components. For example, although FIG. 14 depicts three client computing devices, any number of client computing devices may be supported in alternative aspects.

The term cloud service is generally used to refer to a service that is made available to users on demand and via a communication network such as the Internet by systems (e.g., cloud infrastructure system 1402) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 1410 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 1402 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 1402 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 1402. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 1402. Cloud infrastructure system 1402 then performs processing to provide the services requested in the tenant's subscription order. Cloud infrastructure system 1402 may be configured to provide one or even multiple cloud services.

Cloud infrastructure system 1402 may provide the cloud services via different deployment models. In a public cloud model, cloud infrastructure system 1402 may be owned by a third party cloud services provider and the cloud services are offered to any general public tenant, where the tenant can be an individual or an enterprise. In certain other aspects, under a private cloud model, cloud infrastructure system 1402 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 1402 and the services provided may be shared by several organizations in a related community. Various other models such as hybrids of the above mentioned models may also be used.

Client computing devices 1404, 1406, and 1408 may be of different types (such as devices 1302, 1304, 1306, and 1308 depicted in FIG. 13) and may be capable of operating one or more client applications. A user may use a client device to interact with cloud infrastructure system 1402, such as to request a service provided by cloud infrastructure system 1402.

In some aspects, the processing performed by cloud infrastructure system 1402 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 1402 for determining the intent of an utterance. The data used for this analysis may include structured data (e.g., data stored in a database or structured according to a structured model) and/or unstructured data (e.g., data blobs (binary large objects)).

As depicted in the embodiment in FIG. 14, cloud infrastructure system 1402 may include infrastructure resources 1430 that are utilized for facilitating the provision of various cloud services offered by cloud infrastructure system 1402. Infrastructure resources 1430 may include, for example, processing resources, storage or memory resources, networking resources, and the like.

In certain aspects, to facilitate efficient provisioning of these resources for supporting the various cloud services provided by cloud infrastructure system 1402 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1402 may itself internally use services 1432 that are shared by different components of cloud infrastructure system 1402 and which facilitate the provisioning of services by cloud infrastructure system 1402. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 1402 may comprise multiple subsystems. These subsystems may be implemented in software, or hardware, or combinations thereof. As depicted in FIG. 14, the subsystems may include a user interface subsystem 1412 that enables users of cloud infrastructure system 1402 to interact with cloud infrastructure system 1402. User interface subsystem 1412 may include various different interfaces such as a web interface 1414, an online store interface 1416 where cloud services provided by cloud infrastructure system 1402 are advertised and are purchasable by a consumer, and other interfaces 1418. For example, a tenant may, using a client device, request (service request 1434) one or more services provided by cloud infrastructure system 1402 using one or more of interfaces 1414, 1416, and 1418. For example, a tenant may access the online store, browse cloud services offered by cloud infrastructure system 1402, and place a subscription order for one or more services offered by cloud infrastructure system 1402 that the tenant wishes to subscribe to. The service request may include information identifying the tenant and one or more services that the tenant desires to subscribe to. For example, a tenant may place a subscription order for a chatbot related service offered by cloud infrastructure system 1402. As part of the order, the client may provide information identifying the input (e.g. utterances).

In certain aspects, such as the embodiment depicted in FIG. 14, cloud infrastructure system 1402 may comprise an order management subsystem (OMS) 1420 that is configured to process the new order. As part of this processing, OMS 1420 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 1420 may then invoke the order provisioning subsystem (OPS) 1424 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 1424 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 1402 may send a response or notification 1444 to the requesting tenant to indicate when the requested service is now ready for use. In some instances, information (e.g., a link) may be sent to the tenant that enables the tenant to start using and availing the benefits of the requested services.

Cloud infrastructure system 1402 may provide services to multiple tenants. For each tenant, cloud infrastructure system 1402 is responsible for managing information related to one or more subscription orders received from the tenant, maintaining tenant data related to the orders, and providing the requested services to the tenant or clients of the tenant. Cloud infrastructure system 1402 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 1402 may provide services to multiple tenants in parallel. Cloud infrastructure system 1402 may store information for these tenants, including possibly proprietary information. In certain aspects, cloud infrastructure system 1402 comprises an identity management subsystem (IMS) 1428 that is configured to manage tenant's information and provide the separation of the managed information such that information related to one tenant is not accessible by another tenant. IMS 1428 may be configured to provide various security-related services such as identity services, such as information access management, authentication and authorization services, services for managing tenant identities and roles and related capabilities, and the like.

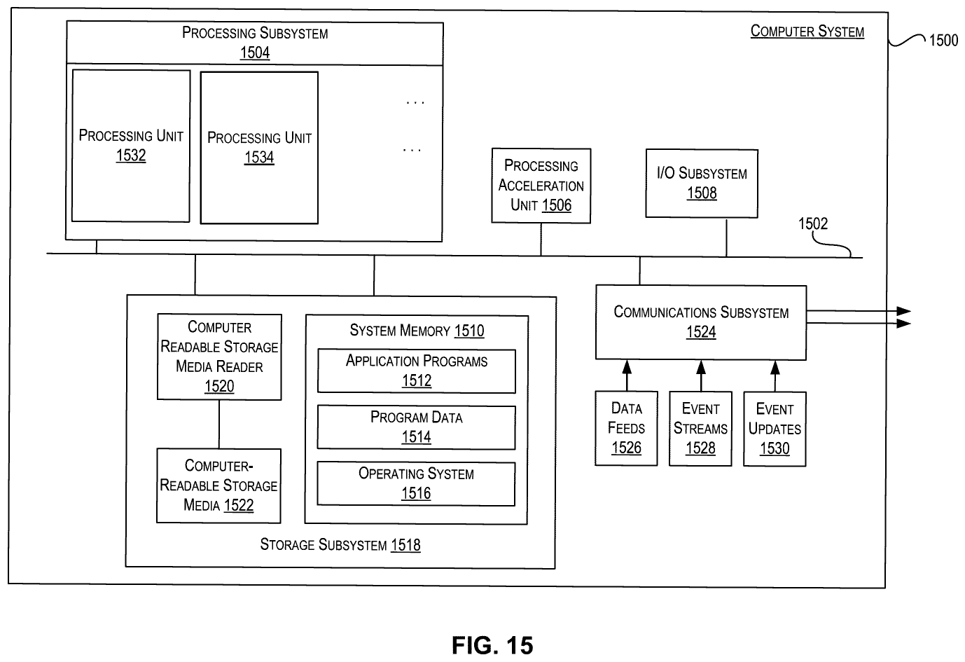

FIG. 15 illustrates an exemplary computer system 1500 that may be used to implement certain aspects. As shown in FIG. 15, computer system 1500 includes various subsystems including a processing subsystem 1504 that communicates with a number of other subsystems via a bus subsystem 1502. These other subsystems may include a processing acceleration unit 1506, an I/O subsystem 1508, a storage subsystem 1518, and a communications subsystem 1524. Storage subsystem 1518 may include non-transitory computer-readable storage media including storage media 1522 and a system memory 1510.

Bus subsystem 1502 provides a mechanism for letting the various components and subsystems of computer system 1500 communicate with each other as intended. Although bus subsystem 1502 is shown schematically as a single bus, alternative aspects of the bus subsystem may utilize multiple buses. Bus subsystem 1502 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1504 controls the operation of computer system 1500 and may comprise one or more processors, application specific integrated circuits (ASICs), or field programmable gate arrays (FPGAs). The processors may be single core or multicore processors. The processing resources of computer system 1500 can be organized into one or more processing units 1532, 1534, etc. A processing unit may include one or more processors, one or more cores from the same or different processors, a combination of cores and processors, or other combinations of cores and processors. In some aspects, processing subsystem 1504 can include one or more special purpose co-processors such as graphics processors, digital signal processors (DSPs), or the like. In some aspects, some or all of the processing units of processing subsystem 1504 can be implemented using customized circuits, such as application specific integrated circuits (ASICs), or field programmable gate arrays (FPGAs).

In some aspects, the processing units in processing subsystem 1504 can execute instructions stored in system memory 1510 or on computer readable storage media 1522. In various aspects, the processing units can execute a variety of programs or code instructions and can maintain multiple concurrently executing programs or processes. At any given time, some or all of the program code to be executed can be resident in system memory 1510 and/or on computer-readable storage media 1522 including potentially on one or more storage devices. Through suitable programming, processing subsystem 1504 can provide various functionalities described above. In instances where computer system 1500 is executing one or more virtual machines, one or more processing units may be allocated to each virtual machine.

In certain aspects, a processing acceleration unit 1506 may optionally be provided for performing customized processing or for off-loading some of the processing performed by processing subsystem 1504 so as to accelerate the overall processing performed by computer system 1500.

I/O subsystem 1508 may include devices and mechanisms for inputting information to computer system 1500 and/or for outputting information from or via computer system 1500. In general, use of the term input device is intended to include all possible types of devices and mechanisms for inputting information to computer system 1500. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1500 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1518 provides a repository or data store for storing information and data that is used by computer system 1500. Storage subsystem 1518 provides a tangible non-transitory computer-readable storage medium for storing the basic programming and data constructs that provide the functionality of some aspects. Storage subsystem 1518 may store software (e.g., programs, code modules, instructions) that when executed by processing subsystem 1504 provides the functionality described above. The software may be executed by one or more processing units of processing subsystem 1504. Storage subsystem 1518 may also provide a repository for storing data used in accordance with the teachings of this disclosure.

Storage subsystem 1518 may include one or more non-transitory memory devices, including volatile and non-volatile memory devices. As shown in FIG. 15, storage subsystem 1518 includes a system memory 1510 and a computer-readable storage media 1522. System memory 1510 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1500, such as during start-up, may typically be stored in the ROM. The RAM typically contains data and/or program modules that are presently being operated and executed by processing subsystem 1504. In some implementations, system memory 1510 may include multiple different types of memory, such as static random access memory (SRAM), dynamic random access memory (DRAM), and the like.

By way of example, and not limitation, as depicted in FIG. 15, system memory 1510 may load application programs 1512 that are being executed, which may include various applications such as Web browsers, mid-tier applications, relational database management systems (RDBMS), etc., program data 1514, and an operating system 1516. By way of example, operating system 1516 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1522 may store programming and data constructs that provide the functionality of some aspects. Computer-readable media 1522 may provide storage of computer-readable instructions, data structures, program modules, and other data for computer system 1500. Software (programs, code modules, instructions) that, when executed by processing subsystem 1504 provides the functionality described above, may be stored in storage subsystem 1518. By way of example, computer-readable storage media 1522 may include non-volatile memory such as a hard disk drive, a magnetic disk drive, an optical disk drive such as a CD ROM, digital video disc (DVD), a Blu-Ray® disk, or other optical media. Computer-readable storage media 1522 may include, but is not limited to, Zip® drives, flash memory cards, universal serial bus (USB) flash drives, secure digital (SD) cards, DVD disks, digital video tape, and the like. Computer-readable storage media 1522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1518 may also include a computer-readable storage media reader 1520 that can further be connected to computer-readable storage media 1522. Reader 1520 may receive and be configured to read data from a memory device such as a disk, a flash drive, etc.

In certain aspects, computer system 1500 may support virtualization technologies, including but not limited to virtualization of processing and memory resources. For example, computer system 1500 may provide support for executing one or more virtual machines. In certain aspects, computer system 1500 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1500. Accordingly, multiple operating systems may potentially be run concurrently by computer system 1500.

Communications subsystem 1524 provides an interface to other computer systems and networks. Communications subsystem 1524 serves as an interface for receiving data from and transmitting data to other systems from computer system 1500. For example, communications subsystem 1524 may enable computer system 1500 to establish a communication channel to one or more client devices via the Internet for receiving and sending information from and to the client devices. For example, the communications subsystem may be used to transmit a response to a user regarding the inquiry for a chatbot.

Communications subsystem 1524 may support both wired and/or wireless communication protocols. For example, in certain aspects, communications subsystem 1524 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1524 can provide wired network connectivity (e.g., Ethernet) in addition to or instead of a wireless interface.

Communications subsystem 1524 can receive and transmit data in various forms. For example, in some aspects, in addition to other forms, communications subsystem 1524 may receive input communications in the form of structured and/or unstructured data feeds 1526, event streams 1528, event updates 1530, and the like. For example, communications subsystem 1524 may be configured to receive (or send) data feeds 1526 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1524 may be configured to receive data in the form of continuous data streams, which may include event streams 1528 of real-time events and/or event updates 1530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1524 may also be configured to communicate data from computer system 1500 to other computer systems or networks. The data may be communicated in various different forms such as structured and/or unstructured data feeds 1526, event streams 1528, event updates 1530, and the like to one or more databases that may be in communication with one or more streaming data source computers coupled to computer system 1500.

Computer system 1500 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1500 depicted in FIG. 15 is intended only as a specific example. Many other configurations having more or fewer components than the system depicted in FIG. 15 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
generating a prompt that specifies a plurality of fields and corresponding values of one or more records; wherein the corresponding values are filled into a prompt template having placeholders for the corresponding values, wherein the prompt specifies a data structure to use for filling in components of a change order; and wherein the prompt comprises a particular natural language description of a particular issue that caused the change order;
prompting a large language model with the prompt to generate a result based at least in part on the corresponding values of the one or more records;
receiving, from the large language model, the result, wherein the result comprises a particular data structure comprising particular values of a particular change order;
causing display of the particular change order and an option to save the particular change order.

2. The computer-implemented method of claim 1, further comprising:
causing display of another option to provide natural language input to modify the particular change order;
receiving particular natural language input via a selection of the other option;
re-prompting the large language model to generate another result based at least in part on the particular change order and the particular natural language input;
receiving, from the large language model, another result, wherein the other result comprises another particular data structure comprising other particular values of another particular change order;
causing display of the other particular change order and an option to save the other particular change order.

3. The computer-implemented method of claim 1, further comprising:
classifying an impact of the particular change order based at least in part on the particular values of the particular change order, and storing a classification as part of the particular change order in a database, wherein the classification is based at least in part on whether the particular change order describes a change including manual labor.

4. The computer-implemented method of claim 1, further comprising:
classifying the particular change order based at least in part on the particular values of the particular change order and a list of candidate change reasons provided in the prompt, and storing a classification as part of the particular change order, wherein the classification is determined based at least in part on the large language model selecting a change reason from the list of candidate change reasons provided in the prompt.

5. The computer-implemented method of claim 1, further comprising:
determining one or more quantified impacts of the particular change order, and storing the one or more quantified impacts as part of the particular change order in a database.

6. The computer-implemented method of claim 1, wherein the placeholders comprise a placeholder for the particular natural language description of the particular issue that caused the change order, and wherein the prompt has the natural language description of the issue at a position that is based on the placeholder.

7. The computer-implemented method of claim 1, wherein the placeholders comprise a placeholder for range-limiting criteria for a field; wherein the prompt has the range-limiting criteria of the field at a position that is based on the placeholder; and wherein the result comprises a value for the field that complies with the range-limiting criteria.

8. The computer-implemented method of claim 7, wherein the prompt further comprises different input examples having different range-limiting criteria and different output examples corresponding to the different input examples.

9. The computer-implemented method of claim 1 wherein the prompt further comprises different input examples having different natural language descriptions of issues and different output examples corresponding to the different input examples; wherein the different output examples have different numerical values for an output field; wherein the different numerical values quantify different absolute impacts of changes based on the issues; and wherein the particular values in the particular data structure comprise a particular numerical value for the output field that quantifies a particular absolute impact of the change order.

10. The computer-implemented method of claim 1, wherein the prompt further comprises different input examples having different natural language descriptions of issues and different output examples corresponding to the different input examples; wherein the different output examples have different numerical values for an output field; wherein the different numerical values quantify different relative impacts of changes based on the issues that are not further quantified into absolute impacts; wherein the particular values in the particular data structure comprise a particular numerical value for the output field that quantifies a particular relative impact of the change order; wherein the particular data structure does not include an absolute amount from which to further quantify the particular relative impact; the computer-implemented method further comprising:
retrieving, based at least in part on one or more values of the one or more records that were omitted from the prompt, a particular absolute amount; and
transforming the particular relative impact into a particular absolute impact based at least in part on the particular relative impact and the particular absolute amount.

11. A computer-program product comprising one or more non-transitory machine-readable storage media, including stored instructions configured to cause a computing system to perform a set of actions including:
generating a prompt that specifies a plurality of fields and corresponding values of one or more records; wherein the corresponding values are filled into a prompt template having placeholders for the corresponding values, wherein the prompt specifies a data structure to use for filling in components of a change order;
prompting a large language model with the prompt to generate a result based at least in part on the corresponding values of the one or more records;
receiving, from the large language model, the result, wherein the result comprises a particular data structure comprising particular values of a particular change order;
causing display of the particular change order and an option to save the particular change order.

12. The computer-program product of claim 11, wherein the set of actions further includes:
causing display of another option to provide natural language input to modify the particular change order;
receiving particular natural language input via a selection of the other option;
re-prompting the large language model to generate another result based at least in part on the particular change order and the particular natural language input;
receiving, from the large language model, another result, wherein the other result comprises another particular data structure comprising other particular values of another particular change order;
causing display of the other particular change order and an option to save the other particular change order.

13. The computer-program product of claim 11, wherein the set of actions further includes:
determining one or more quantified impacts of the particular change order, and storing the one or more quantified impacts as part of the particular change order in a database.

14. The computer-program product of claim 11, wherein the placeholders comprise a placeholder for range-limiting criteria for a field; wherein the prompt has the range-limiting criteria of the field at a position that is based on the placeholder; wherein the result comprises a value for the field that complies with the range-limiting criteria; and wherein the prompt further comprises different input examples having different range-limiting criteria and different output examples corresponding to the different input examples.

15. The computer-program product of claim 11, wherein the prompt further comprises different input examples having different natural language descriptions of issues and different output examples corresponding to the different input examples; wherein the different output examples have different numerical values for an output field; wherein the different numerical values quantify different relative impacts of changes based on the issues that are not further quantified into absolute impacts; wherein the particular values in the particular data structure comprise a particular numerical value for the output field that quantifies a particular relative impact of the change order; wherein the particular data structure does not include an absolute amount from which to further quantify the particular relative impact; and wherein the set of actions further includes:
retrieving, based at least in part on one or more values of the one or more records that were omitted from the prompt, a particular absolute amount; and
transforming the particular relative impact into a particular absolute impact based at least in part on the particular relative impact and the particular absolute amount.

16. A system comprising:
one or more processors;
one or more non-transitory computer-readable media storing instructions, which, when executed by the system, cause the system to perform a set of actions including:
generating a prompt that specifies a plurality of fields and corresponding values of one or more records; wherein the corresponding values are filled into a prompt template having placeholders for the corresponding values, wherein the prompt specifies a data structure to use for filling in components of a change order;
prompting a large language model with the prompt to generate a result based at least in part on the corresponding values of the one or more records;
receiving, from the large language model, the result, wherein the result comprises a particular data structure comprising particular values of a particular change order;
causing display of the particular change order and an option to save the particular change order.

17. The system of claim 16, wherein the set of actions further includes:
causing display of another option to provide natural language input to modify the particular change order;
receiving particular natural language input via a selection of the other option;
re-prompting the large language model to generate another result based at least in part on the particular change order and the particular natural language input;
receiving, from the large language model, another result, wherein the other result comprises another particular data structure comprising other particular values of another particular change order;
causing display of the other particular change order and an option to save the other particular change order.

18. The system of claim 16, wherein the set of actions further includes:
determining one or more quantified impacts of the particular change order, and storing the one or more quantified impacts as part of the particular change order in a database.

19. The system of claim 16, wherein the placeholders comprise a placeholder for range-limiting criteria for a field; wherein the prompt has the range-limiting criteria of the field at a position that is based on the placeholder; wherein the result comprises a value for the field that complies with the range-limiting criteria; and wherein the prompt further comprises different input examples having different range-limiting criteria and different output examples corresponding to the different input examples.

20. The system of claim 16, wherein the prompt further comprises different input examples having different natural language descriptions of issues and different output examples corresponding to the different input examples; wherein the different output examples have different numerical values for an output field; wherein the different numerical values quantify different relative impacts of changes based on the issues that are not further quantified into absolute impacts; wherein the particular values in the particular data structure comprise a particular numerical value for the output field that quantifies a particular relative impact of the change order; wherein the particular data structure does not include an absolute amount from which to further quantify the particular relative impact; and wherein the set of actions further includes:
retrieving, based at least in part on one or more values of the one or more records that were omitted from the prompt, a particular absolute amount; and
transforming the particular relative impact into a particular absolute impact based at least in part on the particular relative impact and the particular absolute amount.
